(19) United States
(12) Patent Application Publication
(10) Pub. No.: US 2003/0228393 A1
(43) Pub. Date: Dec. 11, 2003

(54) Multi-phase food & beverage

(76) Inventor: Iris Ginron Zhao, Philadelphia, PA (US)

Correspondence Address: Iris G. Zhao, # C - 20, 1925 Chestnut Street, Philadelphia, PA, 19103, US

(21) Appl. No.: 10/160,957

(22) Filed: May 31, 2002

(51) Int. Cl. A23K 1/175

(52) U.S. Cl. 426/74

(57) ABSTRACT

A multi-phase food and beverage composition is provided to reduce empty sweet-sour water related disadvantages. The air phase from the invention releases a meaningful smell when being consumed. The solid phase can hold a fluid phase and/or float in a liquid phase. The balance liquid phase has a combination of a pH ranging from about 4.0 to about 8.2, 0-7% by weight of sugar and sweetener, 0-3% by weight of alcohol, and 0-1.2% by weight of salt, which is referred to human physiological body composition for normalizing body composition and fluid metabolism toward optimal body fitness with increased sensory experience and satiety. The invention is suitable for an aromatic air aerated drink, fast fermented grain drink, amino acid flavored soft drink, motion vegetable beverage, cheese ball floated on a liquid, and aerated chocolate.

### FIELD OF THE INVENTION

The present invention relates to a multi-phase food composition with enriched tastes and a method of preparing same. Particularly, the invention is related a multi-phase beverage with a balanced food structure to reduce empty sweet-sour water related disadvantages.

### BACKGROUND OF THE INVENTION

To serve the basic human need for water, hundred beverages have been put on the market to satisfy consumers' taste bud and physiologic need. In the past, various efforts have been given to improve the beverage art. However, high sugar, artificial sweeteners, fructose syrup, citrate acid and chemical additives have been the main taste and preservation used in conventional beverages, which, unfortunately, often negatively affect nutritional balance. For example, U.S. Pat. No. 3,510,310 issued to Breckwoldt provides a method of mixing pre-sweetened with the artificial sweetener N-cyclohexylsulfamic acid by adding adipic, citric, fumaric, malic, lactic, tartaric, or succinic acid. U.S. Pat. No. 5,902,628 issued to Shamil teaches the use of tannic acid for reducing the lingering sweet aftertaste in beverage compositions that have been sweetened with sucralose. U.S. Pat. No. 3,510,311 issued to Swaine et al, teaches a dry beverage composition, containing sodium bicarbonate 30.79%, citric acid 39.2%, sodium citrate 4.2%, mannitol 14%, saccharin 0.13%, vanilla 0.56%, caramel color 2.8%, calcium phosphate 1.5%, and cyclohexylsulfamic acid 1.5%. In many related products, food-grade acids have been used to impart a taste and sense of sourness as typical soft sweet-sour drinks. Consequently, average pH of beverage has been dropped to below 4.0, which can accelerate osteoporosis and increase appetite, and the average ratio of chemicals and refined sugar to natural and non-sugars has been above 9 to 1 that offset whole nutritional balance.

Fruit puree and starch ball are another approach to enrich a beverage. However, fruit puree intends to deposit in the buttons of bottles and becomes less tender. Starch balls intend to be deteriorated overnight and therefore cannot provide a long shelf life as typical soft beverages do. As to hold a volume in the stomach to make consumer feeling full, CO₂ intends to leak through the wall of bottles and can not hold the volume as good as inert air. For the goal of preservation, aroma can kill at least some germs and therefore works better than acids and sugars. As to a enriched taste, the combination of bitter and sweet last much longer and deeper than the combination of sour and sweet, which can only be tasted by the taste bud on the anterior tip of the tongue. Moreover, alkali solutions have a bitter flavor, which reduces both thirsty and hungry symptoms in diabetics, and therefore is superior to sweet and sour. In addition, mild alkali foods reduce osteoporosis and help calcium staying in situ, however, acidic foods and beverages intend to active calcium leaving the bone, which have been a long-last unsolved problem to be addressed in the present invention. Differentiated from U.S. Pat. No. 5,932,251, issued to Morris et al, which used thiazide to increase the pH of body fluid to reduce osteoporosis, the disclosure is reducing the use of acidic chemicals. Further differentiated from prior food and beverages, the main flavor of the multi-phase food and beverage is selected from aroma, amino acids, a little bitter, a little salty, semi-sweet, and edible herb, most of which have alkali characteristics.

Further differentiated from U.S. Pat. No. 5,478,591, issued to Bevers et al, 1995, which is a homogeneous sour liquid made of fruit juice, cocoa, alcohol, and dairy, the features of the invention are multi-phases with uneven distribution. Further differing from U.S. Pat. No. 5,567,424, which comprises pepsin, papain and bromelain, the present invention does not provide these enzymes.

Different food and beverage compositions originate from different views of these matters. Sweet/sour/ice beverages should not be the best and main taste in beverage art as they have been. For example, public concern in today's market is the fat content of a product. Instead of high fat, many consumers have taken these high sugar/acid/artificial additive drinks as a “dietary effort” and expect high performance to be the consequence. Although the nation's fat intake has been reduced from 40% of total calories to 37% recently, the percentage of overweight individual in the population has not reduced accordingly. According to USDA and RDA, sugars and starches together contribute 45% of the energy in men and 46% in women. About half of the total digestible carbohydrate intake is monosaccharides and disaccharides from fruits, soft drink, milk, candies, and sweet dessert. 25% of total carbohydrate intake (11% of total energy) is provided by adding sweeteners, most sucrose and high-fructose corn syrup (Glinsmann et al., 1986). Some conventional beverages even contain more than 90% by dry weight of artificial additives or chemicals and almost 95-100% by calorie of simple sugars but very few nutrients, except cider containing about 2.61% by calorie protein. The empty calorie from sugar and chemical load without adequate assistance from fiber, protein, fat, vitamin, and mineral for utilization may not only cause glycemia frustration, but also break the balance between insulin and glucagon axis. Excess glucose intends to be converted to adipose tissue under the influence of combined hyperglycemia and hyperinsulinemia, which rises by quickly absorbable sugar intake. Consequently, it will block the utilization of fat as a fuel and therefore the body will not burn the fat, which upsets the consumers' effort on weight control. Really, the overload of high water soluble small molecule sugar should be avoided in consumers with glucose intolerance due to hyperglycemia related complications. Plus, high sugar intake is less likely to result in a high performance than a balanced diet because of bonking, drowsiness, tiredness, and increased sugar crave. For example, without the assistant of V_{B1}, carbohydrate cannot even be burned completely. Furthermore, high sugar intake is known to increase blood triglycerides and depression. In contrast, a ratio of 3 parts protein to 4 parts carbohydrate for the swimming team in Stanford University showed better sport performance than high sugar only (Dr. Barry Sears & Bill Cawren, The Zone, Harper Collins, 1995). Such high performance is likely induced by glucose release from carbohydrate plus protein-induced gluconeogenesis, which prevents the blood glucose fall back. However, simply combining carbohydrate and protein still has not been be the best because this coaction for blood sugar increasing is stronger than carbohydrate alone, which would not be a problem if the consumer is young and has plenty capacity of compensation, but may cause tissue and eye damages in diabetics. By contrast, at least, fat induces cholecystokinin and satiety without directly rising glycemia. Proteins build up the body structure, muscle, neurotransmitter, hormone, enzyme, and has a high turn over rate. The human body could not make essential amino acid and essential oil, which needs frequent supply. In addition, it has been a common eating experience that rich protein food, e.g., egg, meat, and milk makes people feel satiated, happy and energetic. Emphasis on calories certainly should not distract attention from other nutrients, especially, essential amino acid. Beside the view of nutrition, amino acids provide appealing taste in the present beverage that the traditional soft drink does not have.

Low fat diet lacks essential fatty acid that is critical in hormone regulation, eicosanoid and prostaglandin synthesis, cell membrane plasticity and immune response, and nervous transmission. Also, recognizing the fact that many consumers can't take off work to exercise and most dietary programs need special training and major change of eating habits, holding back their practice in realty. Since overeating unbalanced food with reduced activities has been the main cause of overweight, a balanced drink/diet within the frame of reduced calorie allowance has to be on the way for development. Besides, adipocytes can synthesize adipose tissue lipoprotein lipase, which causes preferential storage of excess fat and calories in adipose tissue. More important, levels of this enzyme do not return to normal following weight reduction. This finding is of particular interest because it is one of the few characteristics of the obese state that is not corrected by weight reduction and could explain the propensity of obese to regain lost weight (Harrison's Principle of Internal Medicine, Part 5, p 447-448, Nutrition, 1995). To solve these long last unsolved drink and eating related problems, the present art is to make the energy supply flatten over a prolonged period of time after drinking and eating and to use balanced food and drink for preventing high blood glucose caused damage and weight gain. Above all, nothing is more enjoyable than a balanced food and beverage, which offers not only cooperative health benefit but also delicious taste coaction among food categories for enriched sensory experience and positive feedback. Thus, the chance of adding extra adipose is reduced in a feasible manner to every consumer at all times as the disclosure intends to do.

Moreover, noticing the fact that 30% population have an overweight problem and more than 5 million people are receiving diabetic treatment, diabetes has been the main cause of vision loss in American. As most authorities recommended that the aims of diet in overweight and obese type II diabetics are losing weight and controlling hyperglycemia, however, acidic sweet drink with phosphate increases appetite, which may benefit consumers in chemotherapy and gastric acid deficiency, but not the overweight. This is another unrecognized matter. A sugar beverage can rise plasma glucose levels immediately, however, it can fall back very quickly also because glucose self does not induce gluconeogenesis. Plus, high sugar intake, e.g., 20% sugar, acts as osmotic diuresis and consequently dehydration may occur. Thus, more water will be required to balance the body Osm, which will increase the feeling of thirst. Furthermore, hyperglycemia relates to severe retina and kidney complications as well as the reflex index of the eye lens. Increasing the lens refraction power could cause blurred vision in myopia and temporally reduced presbyopia, which misleads the consumer to suppose that his/her vision is getting better for reading. When blood sugar is above 180 mg % of the kidney threshold, the sugar starts to leak into the urine. To solve these empty sweet/sour water problems inherited from prior beverage, the disclosure sets up limits in the light of normal human body/fluid values that the body is working hard to keep and focuses on healthy coaction of taste of the whole tongue, mouth and throat, smell of the nose, vision of the eye, audio of the ear, and improved mood with combined diversity of nutrients for normalizing body metabolism. Another goal of the present art is to provide a novel beverage capable of avoiding a big initial surge in the level of blood glucose after being drunk, instead they give rise to a lower glucose release spread over an extended period of time. Further project of present invention is to incorporate the natural vegetable/herb/protein soup with high technology of current beverage process for optimizing the enjoyment of drinking art. Contrary to prior art's teaching, the application emphasises on the harmony of coaction among bioactive components, taste contrast and penetration during process to bring out the best in each and every way possible. The essence of the present art is the recognition of the problem. As the subject matter was never recognized, the solution would therefore possess unobvious novelty over prior records.

### DESCRIPTION OF THE DRAWINGS

FIG. 1 shows the relationship among standard pyramid food structure, typical soft drink, and present food and beverage.

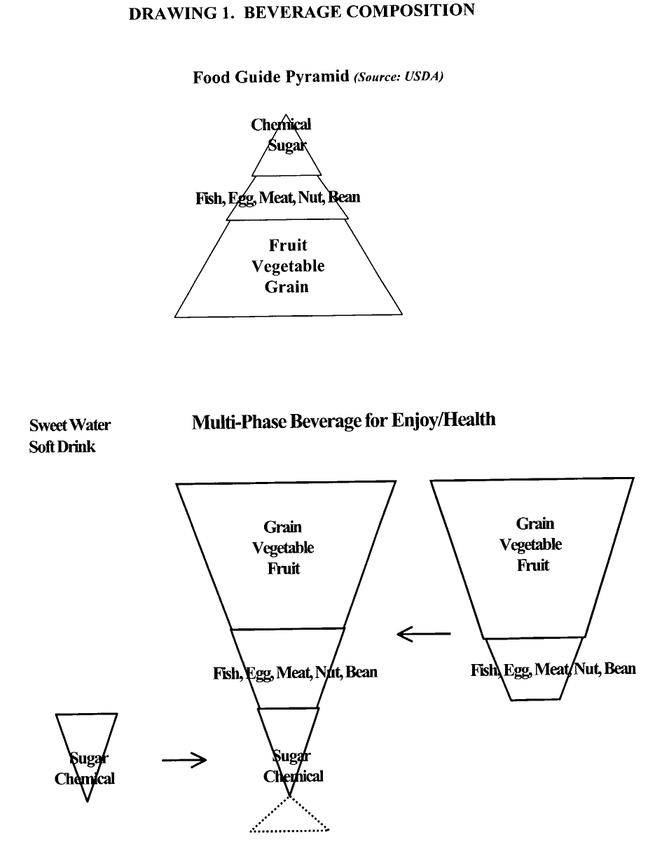

FIG. 2 is a flowchart showing the method of making the beverage.

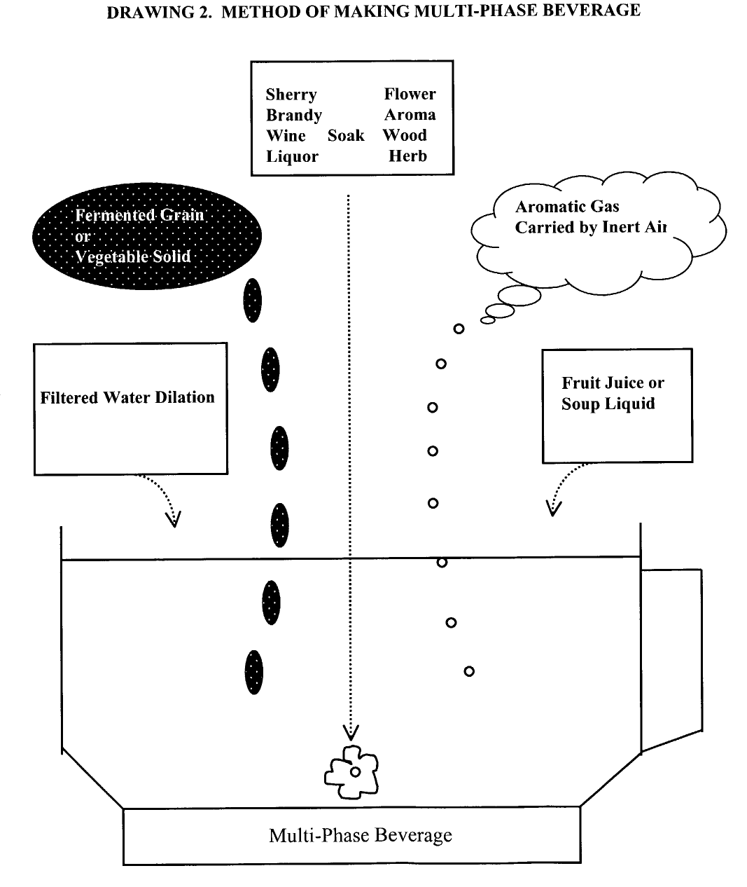

FIG. 3 shows the model of the multi-phases and layers of various flavors in the beverage.

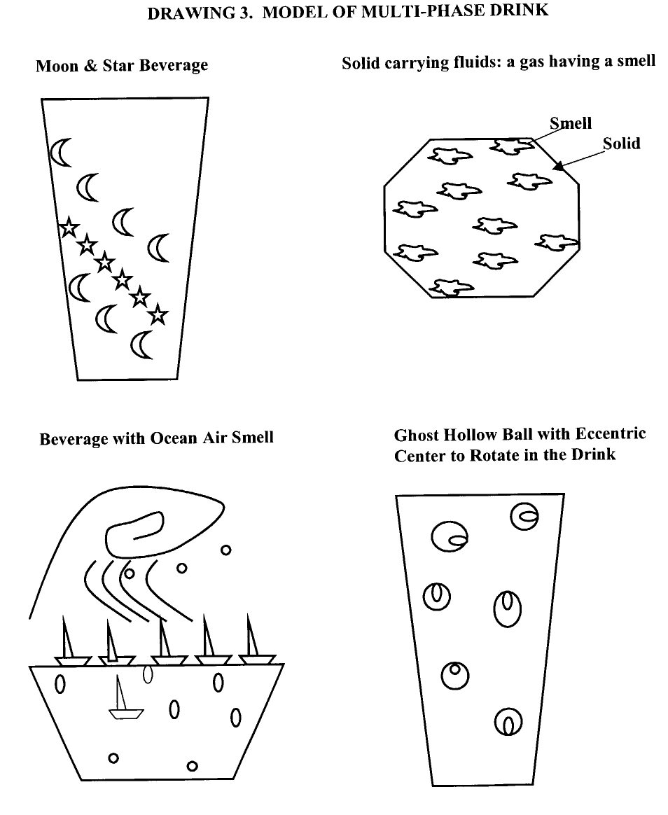

The aroma can be carried by a fluid phase, e.g., water, diluted wine, beer, milk as a flavor, bean milk, grain milk, soup, soft drink, juice, cocktail, porridge. A solid phase can also be a good carrier for an aroma and liquid phase.

FIG. 4. shows a motion drink with extendable solids.

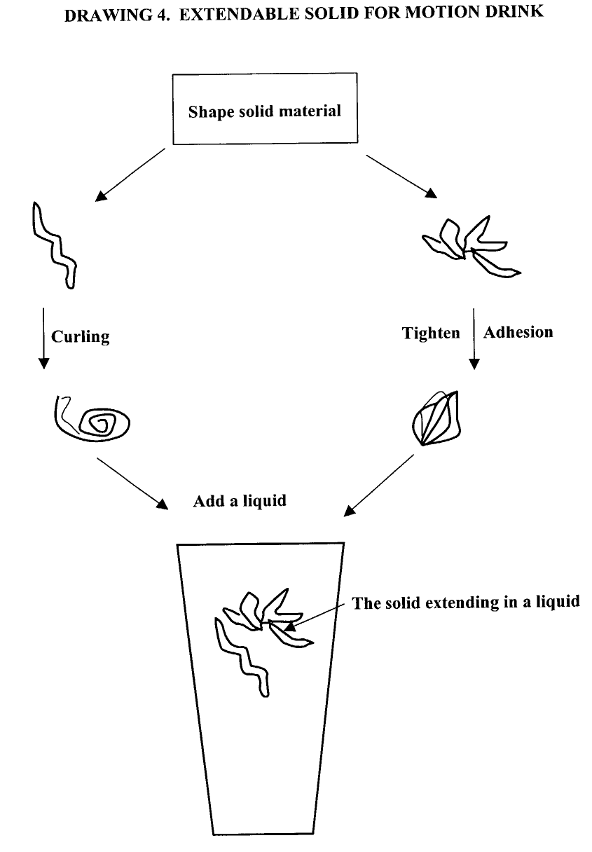

FIG. 5 shows the method of preparing a solid having density gravity close to water capable of floating on a liquid.

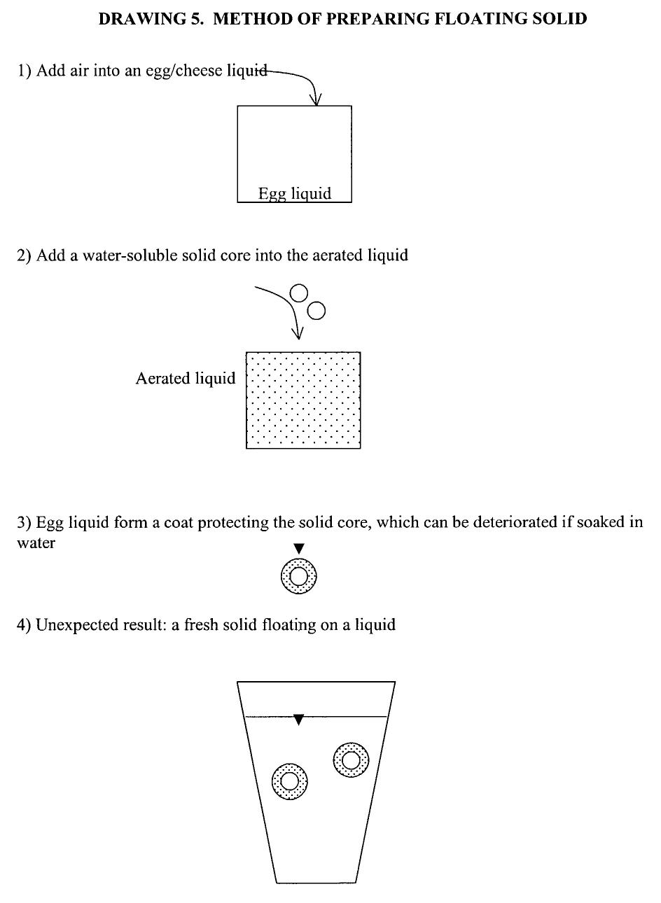

### DETAILED DESCRIPTION OF THE INVENTION

To overcome prior separation among air aroma fresheners and soft drink industries, the present invention adds about 0.5-7% by volume of aromatic air into a pH balanced drink. The present food and beverage use only aromatic non-toxic air for air phase. In general, aroma gives people a pleasant feeling and is known to help the immune system to kill air-borne bacterial and germs. Many manufactories, e. g., SKC Inc, can analysis a special smell in a very small amount. Actually, normal people may tell the difference if there are 3-5 molecules of the smelling material reached their smell organ on the nasal mucous. However, some air fresheners may be filled with chemicals and artificial fragrances, which contribute to air pollution and is not included in the present food and beverage. For example, polycyclic aromatic hydrocarbons (the smells from incomplete burn of coal, grill or cigarette) must be avoid. The most common ways of dispersing essential oil in prior art are diffuser using a micro-fine vapors, vaporizers and humidifiers.

In contrast to prior beverage, this invented beverage has a pleasant smell made of an aromatic air phase, which is pressed into the liquid and will be evaporated once the pressure is reduced. As a carrier, both CO₂ and alcohol will accelerate the evaporation of aroma. The aromatic air fresheners used in the invention comprises peppermint, lavender, rose, lotus, eucalyptus, jasmine, orange, geranium, osmanthus, oak, pine, fur, saddle, and their imitations. The aroma is carried by alcohol, inert air, CO₂, or filtered air through mixing. Some fresh smell can also be obtained by sucking the air from forest.

It is not known to provide a multi-phase food and beverage as the following:

(A) a liquid phase having a combination of pH range from about 4.0 to about 8.2 and 0-7% by weight of simple sugar and sweetener, and 0-1.2% by weight of salt. The goal of the disclosure is to offer a neutral soft drink to reduce the adverse effect, e.g., osteoporosis, appetite increase, from main acidic drink on the market that has average pH about 2.7-4.5. The bounds and meters of sweetener and salt concentration are based on the physiological value of human body fluid, which the body tries hard to maintain. The goal for the disclosure is jto offer a food and beverage close to physiological range to make it easy for the body. Actually, the body feels comfortable to take a food and beverage that is most needed to maintain its normal value. High concentration simple sugar and chemical load, and consequently induced blood glucose and osmority frustration as mentioned before is carefully reduced. For example, one occasion of 500 ml of beverage should contain less than 50 grams of glucose, which is used to induce a positive pregnant glucose test, which means no more than 10% by weight of sugar. To be in a more preservative range, the present beverage has set the boundary line of sugar and sweetener concentration under 7% by weight to avoid glucose and osmolity stress. Although the use of sugar and sweetener are well known in art, it has been focused on how to make it taste sweet. Glucose test is strictly limited within the bounds of medical practice rather than the field of soft drink. So far, no one has brought this useful concept to the skilled in the crowded field as a healthy solution for dietary improvement.

(B) an air phase, consisting of a gas carrying an aromatic smell, an inert gas, and a filtered gas. Most soft drinks in the market are found to use carbonation for the fresh feeling and the foaming head. However, as indicated in the disclosure, there is a better approach if the CO2 is carrying an aroma and fresh smell. Ether and CO2 have high penetration power, which can be used as an excellent carrier to bring the aroma out of liquid. Plus, ether can reduce the surface tension of liquids and help an air phase with flesh smell to break the liquid surface. The advantage of inert airs is their stability, which intends to stay within the beverage without significant leakage through the wall of bottles. Thus, the combination of such air phases is useful and novel. Especially, with the help of high technology used in chemical industry and smell test, a pleasant fresh smell from a healthy food and beverage is on its way to consumers in realty.

The air phase of the invention is selected from the group consisting of a gas carrying a nontoxic aroma, an inert gas, ozone, N₂O, ether, and a filtered gas. The aroma will be released under one of the following conditions:

1) when the pressure on such air phase is released,

2) when the temperature of such food mixture is rising,

3) when such food mixture is chewed.

(C) a solid phase has a mean dense gravity close to water, and contains at least 10% by weight of water stable material including protein, fat, water-insoluble plant fiber, algae, and sea organism. For example, egg, dairy, cocoa, meat, soy, water insoluble fiber, seafood and poultry. The solid used for drink should have a smooth surface have a size ranging from about 2μ to about 1 cm by diameter so that it can be easily sucked into a straw. The size of the solid used for holding an air phase can be much bigger, such as from about 0.5 cm to about 10 cm or even bigger, which can be any consumer acceptable shape from animal to plant. The volume of an air phase to be pressed into the multi-phase beverage should be about 0.5-7% by volume to be in a safe range. The volume of the air phase to be hold within a solid can be in a range from 10-70% by volume of the whole food.

Algae and sea organism have native cell wall and membrane which are water stable against the even distribution force from the outside ocean. Fat, by nature, is water phobic. Protein, e.g., egg, soy, dairy, agglomerates by heat and chemicals and has excellent tenderness. Meat can be mashed and optionally mixed with liquid to form a thick liquid, which can be clotted as a coating or floating pieces.

Although these phases may be mixed together suitable to form a novel tasty multi-phase food and beverage, each phase holds its unobviousness over prior teaching.

A water-soluble solid core may be rotated in an egg liquid to obtain a liquid egg coating and thereafter be heated to clot suitable to form a water stable solid coating with a water-soluble core.

The filtered air used in the invention is filtered through a pore ranging from about 1μ to about 10μ by diameter, preferably through a pore ranging from about 1μ to about 5μ by diameter.

The solid phase used in the invention is aerated to reduce density gravity close to water suitable to float in a liquid solution.

The disclosed solid phase may hold a fluid chamber carrying a smell within such chamber. Such smell will be released when the chamber is opened.

The multi-phase food and beverage according to the invention may have a solid phase holding a fissure so that a voice will be created when there is some material flowing through such fissure.

The solid phase may contain an inclusion having flowing characteristics in consumable temperature as a fluid. The solid is obtained through the following steps: a fluid inclusion firstly be frozen to form a solid core and then be coated by a solidable liquid, e.g., egg, cheese, chocolate.

Egg liquid should coat the solid core in a cool room temperature, e.g., 1° C.-24° C. and then be heated in a temperature from about 60° C. to 105° C. suitable to form a water stable solid shell. Cheese and chocolate can coat a solid core in a hot temperature ranging from about 38° C.-65° C. and 50° C.-99° C. respectively, and later be cooled and agglomerated to form a water stable solid shell sealing and holding their cores. Comparing to the creamy mouth feel from fat solid, protein solid can offer more tenderness for chewing. No matter this is an eggshell, chocolate coating, or cheese covering, the frozen solid should regain flowing capacity at room temperature. Since it is not known how to prepare a multi-phase food and beverage through such double temperature process, the present art is unobvious in the field of soft beverage.

Originated from the heat process and chemical technology used for woman's hair wave, the disclosure pre-curls and tightens a solid piece in a dry condition to a consumer acceptable shape so that when a liquid is added, such pre-curled and tighten solid piece will absorb the moisture from such liquid and therefore extend and inflate in the liquid to perform a motion as a movable solid phase, which brings up a surprise result to the skilled in the art of food and beverage. Also differentiated from hair perm., which is intend to keep the hair in the fixed way, the present invention is using such technology in a reversed way, which is unknown to the skilled in the art of hair treatment.

The solid phase used in the invention have a mean density gravity close to water, however, its gravity center may not be at the geographic center and therefore, an unbalanced gravity force from said eccentric gravity center drives said solid phase to rotate suitable to perform a motion in a liquid phase as a movable solid phase, which offers an unexpected view to please consumers.

The method of preparing this multi-phase food and beverage comprising the step of providing a liquid phase having a combination of a pH range from about 4.0 to about 8.2 and 0-7% by weight of simple sugar and sweetener, and 0-1.2% by weight of salt.

An air phase can be added into a liquid or solid phase. The air phase is selected from the group including a gas carrying an aromatic smell, an inert gas, ozone, N₂O, ether, and filtered gas. The pores for filtering the air phase range from about 1μ to about 10μ, preferably from 1μ to 5μ to reduce microorganism contamination and unwanted dust. The device can be obtained by air purifier, e.g., Holmes. A solid phase can be added into a liquid. Such solid should have a size from about 2μ to about 1 cm by diameter, a mean dense gravity close to water, and containing at least 10% by weight of water stable material, which isolate the solid from the liquid and therefore overcomes the prior spoiling problem. The solid phase can hold several liquid chambers and have a medium size from about 1 cm to 5 cm by diameter. The solid phase can hold many aroma chambers and can have a bigger size from about 1 cm to 20 cm.

This method of preparing the multi-phase food and beverage provide consumers a pleasant surprise, e.g., a fresh smell air aerated drink, a food making a noise, a water stable solid capable of being sucked into a straw from a liquid, a solid food being capable of releasing an aroma from its chambers, a chocolate coated solid floating on a liquid, a cheese solid ball holding a fluid inclusion.

Above multi-phases work together to approach an enriched sensory experience and satiety satisfaction, to improve human body fluid and weight control as a fast food and enabling diverse axes of systems to be held around one physiological center as a stereo ball in dynamic movement. The improvement comprises multiple phases and categories of foods in proportional close to optimal level to reduce adverse effect so that such balanced combination cooperates from different angles to increase their nutritional function toward its optimal values and to enrich the taste development against off-flavors. Such food mixture can be dehydrated as a home package and then be diluted to obtain a drink. The condensation of the product can be vacuum/cold stored to make a fresh hot drink or a quick cool beverage as a fast food. Preferably, the size of the solid in the beverage is about 0.1 mm³-1 cm³. This method is particularly suitable for a motion solid to perform a free movement with the flexibility and gravity support from a liquid. Small solid pieces can be curled or tighten before dehydration. Also the solid can have bias or be eccentric cam to accelerate a motion perform. Liquid supports free motion better than air phase. Since food usually is in a static status and does not relate to a motion, the method of preparing the motion solid and the result became a real surprise. Such motion food can give customers an amazing joy even before being eaten and will bring up the best of every ingredient deep in the nature.

The beverage is a liquid enriched by gas, solid, or both, containing: 65-99% by weight of water with 1-35% by weight of solid and/or 0.5-6% by volume gas. This food comprises: 0-7% by weight of honey, glycine, or fructose, 0-3.0% by weight of alcohol, 0-7% by weight of total simple carbohydrate (sugar and starch), and 0.002-2% by weight of fiber. The solid can be mixed in advance or be added before consumption. The liquid phase can be held in a container or by a solid phase. Liquid eaten with solid significantly increases the gastrointestinal empty period over liquid alone. Air phase releases the aroma of flower, wood, herb, vegetable, seasoning and amino acids. Rather than searching every corner in the world for good taste, protein is the best flavor. Amino acids, e.g., phenylalanine, are not only tasty but also can make consumer feel satisfied and help utilizing carbohydrate and proper gluconeogenesis to burn fat. Finally, this multiple phases/categories food offers a synergetic coaction toward normalized body fluid and substance metabolism with full-developed Drinking Art and Art of Drink®© into a cup of beverage.

Once the separations between the preparation of fast food/drink and nutritional balance is recognized, the solution becomes obvious for those skilled to maintain a health position over time. For example, there are several aspects to the present invention as set forth for clarity below:

1. Osmolality & pH Balanced Beverage

Differentiated from typical soft drinks containing more than 90% dry weight simple sugar and chemicals with most pH ≦3.5 and not considering Osm balance at all, the essential improvement of this drink is to keep mineral and sugar osmolality between 0-300 mOsm and pH between 3.5 and 8.2, restriction of simple sugar to 0-7% by weight, and chemical additives 0-1% by weight with fiber 10-37 grams in 2000 calories of food and beverage to reduce small molecular particles induced osmolality stress. Alcohol has high penetration power and is difficult to be compared with mineral and sugar. The present flavor is not based on sweet, sour, and carbonation, rather, is set forth on aroma, bitter taste, amino acid, mild salt, semi-sweet, pungent, beer flavor, and wine-like ether. Since most bacteria use sugar for their energy, the sugar should be kept in a hypertonic form before dilution, or be solved in an alcohol solution to extract aromatic materials.

COMPARATION OF OSMOLALITY & pH

| Beverage | mOsm | pH | Glucose levels | Protein |
|---|---|---|---|---|
| Human serum | 275-295 | 7.35-7.45 | Fasting: 70-110 mg % | 6-8% |
| | | | 2-h postprandial < | |
| | | | 120 mg %* | |
| Disclosure | 0-300 | 4.0-8.2 | 0-7% | Y |
| Water | 0 | 6.5 | | No |
| Bamboo water | 0-275 | >6.5 | | Y |
| Beer** | 860 | 4.35 | | Y |
| Tea*** | <275 | 4.2 | | Y |
| Wine | 1720 | 2.3-3.8 | | Y |
| (8% ethyl | | | | |
| alcohol) | | | | |
| 3.5% sucrose | 120 | | | No |
| 20% glucose | 700 | | 20,000 mg % | No |
| Tomato | | 3.7-4.7 | | Y |
| Pears | | 3.4-4.7 | | Y |
| Grape | | 3.3-4.5 | | Y |
| Soft drink | Not | 2.7-3.5 | 10 g % sugar ≈ | No |
| | balanced | | 10,000 mg % | |
| 5% Sugar or | Isotonic | | | No |
| 0.9% NaCL | | | | |
| Orange | | 2.8-4.0 | | Y |
| Cranberry | | 2.3 | | Y |
| Lemon or Lime | | 1.8-2.4 | | Y |
| H₂CO₃ soda | | | | No |
| drink | | | | |
| HCL: tissue | | 1.5 | | No |
| damage | | | | |

*USMLE Laboratory values in biochemical profile
**Morris Jacobs, PhD, The chemistry & technology of food & food product, Vol. 3, 2nd Revised, 1951
***Clark DC et al, Acidity of common foods and beverages, 1990

2. Liquid Phase & Flavors

The total body water content of adult men varies from 55% of body weight in the obese to 65% in thin individuals. Values for adult women average about 10% less (Merck Manual 17th Edition, Water Metabolism, 1997). Water is the highest content for the body structure and metabolism. Human, by nature, loves to drink water. Generally, 1 ml of water per kcal every expenditure is recommended as the water requirement for adults under average condition and is often increased to 1.5 ml/kcal to cover variations in activity level, sweating and solute load. In other words, most adults need 2,000-3,000 ml water per day. As aging is associated with chronic dehydration, many people use water therapy for their health improvement. Although water, consumed as water, is a major source of liquid in some parts of the world, much of the water consumed in the United Sates are taken in the form of soft drink, coffee, tea, and milk. Median daily intake of water as such among respondents in the 1977-1978 nationwide food consumption surveys was 2.8 cups (USDA, 1984, Recommended Dietary Allowance, National research council, 10th edition, p249-250, 1999). However, in the scale of beverage manufacture, sugar solution readings lies mainly between pH 2.5 to 6.5. Boiled high concentration sweets can reach the acidity as low as pH 2.2. 26% sucrose solution converses its pH to about 3.75 and 7% sucrose converses its pH to about 4.5 (R Lees & E B Jackson, Sugar Confectionery & Chocolate Manufacture, p 9-11, Leonard Hill Books, 1973). Most meat tends to become acidic also. Phosphate acid is widely used in conventional beverage, which provides a fresh feel but can be a burden for consumers with kidney problems. Acid, coffee, and phosphate increase urinary loss of Mg and Ca, which relate to hypertension and osteoporosis. Citric acid does reduce urine stone, however, too much citric acid will reduce calcium deposit in bone as well. Reduced sugar intake will not only reduce the blood glucose frustration and teeth caries, but also help the body keep neutral pH. As opposed to low pH, high pH can cause salt deposit in the urine, which relates to urinary stone. Thus, the disclosure has restricted its pH in a range from 3.5 to 8.0. Mild acidic or near neutral, e.g., pH 4.5-7.2, is preferred because natural Vc and V_{B} is unstable in alkali liquid.

Half of saline solution in the stomach will leave in 12 minutes. Gastric emptying is fastest at 200 mOsm NaCL. Pure water and solution <200 mOsm empty more slowly. Above 200 mOsm NaCL, the rate of emptying is inversely proportional to the salt content. Wine, is expected to flow through the pylorus like water. Strong drinks, e.g., whiskey (50% ethanol) almost doubled the time required for half of liquid meal to leave the stomach. However, fatty canapes do little to diminish the effect of ethanol alcohol, because it is rapidly absorbed through the gastric mucosa (H. W. Davenport, Physiology of Digestic Tract, 5th Edition 1982). Thus, the beverage is to provide hypotonic liquid phase with high-density/hard solid phase to delay gastric emptying. Alcohol in the beverage is used as a flavored aromatic carrier as well as direct energy release and sterilizer.

The liquid contains fast-fermented grain fluid, wine-like solution, milk, yogurt, soybean milk, bean milk, herb tea, soup, and water with an aromatic gas, which evaporates under room and body temperature. The beverage is incorporated with edible herb, vegetable, flower, protein, grain, bean, and fat. For example, the flavor is selected from kelp, lotus leaf, bamboo shoot, bamboo leaf, corn skin, ginger, tangerine and orange skin, bitter melon, pine, oak, hickory, almond, saddle wood. Aromatic seasoning, e.g., aniseed, cinnamon, rosemary, thyme, bay leaf, basil, balm leaf, almond, clove, fennel. Vegetable, e.g., green pepper, cabbage, mushroom, sprout, celery, parsley, cilantro, chicory, spinach, sea plant, carrot, yam. Flower, e.g., sweet olive, rose, jasmine, plum, chrysanthemum. Protein, e.g., broth, amino acids. Fruit, e. g., pear, papaya. Grain and bean, e.g., barley, millet, rice, red bean, mung bean. Edible herb, e.g., peppermint, liquorice, stevia, konnyaku, lycium, polygonatum, radix ophiopogonis, radix adephorae, rhizoma polygonati odorati, xanthoxylum, root and stack of glutinous rice. Endive, cress, radish, chive, and salsiby can also give the beverage an identical flavor.

The present beverage is novel and rich but it is balanced, giving consumers a moment of rich enjoyment during lunch break, and maximum relaxation in the evening with a smell induced free imagination to start from. Studying chocolate art from Nestle and Hershey, lecithin is best used for merging hydrophobic fat with solid but not hydrophilic liquid drink. Thus, lecithin is not used in the present beverage. In reverse, the application is not intending to emulsify all phases into one homogenous drink at all. For example, alcohol is not only used as pungent and sparkle flavor but also as a surface tension releaser to free deep aroma from deep inside of a liquid. Actually, present art sets up multi-phases/flavors in one product to increase the contrast and sensitivity between different senses over extended period of time as a stereo food to work cooperatively. In addition, why should solid phase be static and quiet? Solid material can easily be curled and tighten into small balls or any shape that can extend and move as a motion food once a liquid is added.

PROVIDING & USING FLAVORS

| Flavor | Benefit | Caution |
|---|---|---|
| Alcohol | Soak & sterilize aromatic material, ↑ flavor | Diabetes |
| | Quick energy release | Avoid >15 g/day |
| Liquorice | Fresh & soft sweet flavor. Sooth | Sodium retention agent |
| | abdominal pain. Glycyrrhizin helps | May ↑edema, hypertension, or |
| | balancing hormone level. ↓carcinogen. | headache |
| Stevia | 3 times sweet as sugar. Help diabetes | Herb |
| Glycine | Sweet taste, rich body | |
| Ginger | Its geranio ↓cancer, ↓nausea/dizziness | |
| | Sooth common cold | |
| Cinnamon | ↑Shelf time & flavor | Hot flash, heat intolerance |
| | ↑Cold tolerance | DNA mutation? |
| Basil | ↑Flavor, ↓nausea | Aroma |
| Tea | ↓Cancer/heart disease, ↓teeth caries | Chemical or pesticide residue |
| Caffeine | ↓Migraine, combat fatigue, ↑urine | ↓Retinal blood flow by 13% |
| | | Caution in pregnancy |
| Cysteine | ↑Glutathione for the eye | |
| Parsley | Its polyacetylenes ↓ PG and ↓ prostate | |
| | cancer, Its coumarins ↓ blood clot as a | |
| | national blood diluter | |
| Cyclohexylsulfamic acid | Preservative for good flavor | Chemical |
| Mannitol | Flavor | Small molecular sugar |
| Sorbitol | flavor | Small molecular sugar, cataract |
| Rosemary | ↑Meat/fish flavor, ↑memory | Bleeding |
| | Quinones ↓ carcinogen effect | |
| Peppermint | Fresh flavor | |
| | Soothing summer cold | |
| Bamboo/Lotus leaf | Aroma, ↓spoiling, ↓ eating urgency | High oxalic acid is associated to |
| | Cool nature, ↓fever, native preservatives | stones |
| Parsnip | Mild sweet & sharp condiment | |
| Rhubarb | Purgative, flavor, ↓constipation | |
| Edible flower | Flavor & aroma & ↓ bacterial infection | |
| Non toxic wood: oak, | Flavor & aroma & ↓ bacterial infection | |
| pine, fur, sandalwood, | | |
| hickory | | |
| Mannitol | Flavor | Small molecular sugar |
| Sorbitol | Flavor, preservative | Small molecular sugar |
| Phosphate | Fresh mouth feeling | Kidney burden |
| Tannin | Flavor | Constipation |
| Caramel color | Flavor | Constipation |
| CO2 | Foaming head, Sparkling | Stomach upset |
| Citric acid or citrate | Sour fruit flavor, ↓ stone | Calcium/Magnesium lose |
| Malic acid | Round fruit flavor | |
| Vanilla | Rich flavor | |

3. Providing & Using Air Phase, Aroma, & Smell

The sense of tastes is intricately linked with the sense of smell. Many researchers believe the capacity to perceive various senses involves a synthesis of chemoreactive nerve impulses and coordinating brain processes. Inert air, e.g., nitrogen, in comparison to CO₂, is less likely to permeate through a bubble wall, and therefore the bubble is relatively stable. So, the aroma carried by an inert air will last longer. Due to the low solubility of nitrogen, pre-dissolved N₂ at elevated pressure will rapidly carry aroma and smell flow out of the solution. Preferably, such air is filtered and compressed before being delivered to a beverage chamber.

Aromatherapy is incorporated into the gas phase in the beverage so that the aroma, sweet and nutrition work together not only for best flavor development, but also for improving drinking-related conditions through diverse physical layers. According to Hückel's rule for aromaticity states, if the number of electrons=2+4 n, where n=0, the system is aromatic. The smell of this product is not limited to Hückel's rule, instead, is selected from any air phases and evaporations that has a pleasant smell and does no harm to a human body. Approximately 0.5-6% by volume gas (prefer 1.0-3.5 by volume) is added into the beverage. The smell gives human a comfortable and pleasant feel, e.g. aromatic amino acids, sweet-scented osmanthus flower, rose, hop, forest air, ocean order, ozone, N₂O, plum blossom, fresh grass smell, rain smell, roasted nut smell, bakery smell, cocoa smell, coffee evaporation. Other aromatic organic elements includes essential oil, fruit ether, aldehyde, acetate, acyl, acetyl, acetone, hexane, and a gas capable of calming eating and smoking urgency. The gas will be gradually released when the pressure is decreased or when the temperature is rising. The air bubbles increase the contact area and the intensity of sensory stimuli of smell, touch, vision, imagination and taste as an integrity, enabling the beverage to offer more satisfaction within the frame of less calories.

For example, even though female flowers of the vine Humulus Lupulus are a recent addition to beer after 16th century, it has significantly improved the quality of many beers. Therefore, it is an object for the disclosure to extend the use of hops, edible flower, aromatic herb or wood to this beverage and drink. Differentiated from typical beer making, which boils both sweet wort and hops, the disclosure separates it to two steps as: 1) Use high concentration brandy or wine to help sterilizing, extracting, and developing the aroma and flavor. (Edible flowers should not be removed.) 2) Add 1) to the final beverage and therefore the flavor will be sharp and the alcohol concentrate will be diluted to less than 3%; or freeze 1) to form a solid core, coat and rotate such core in a solidable liquid to form a ball and thereafter solid such ball so that the inclusion of the ball comprises a highly concentrated aroma, flavor, and alcohol but the average concentration of the alcohol in the entire beverage can be reported as negative.

4. Providing & Using Solid Phases & Contrast

The solid in the beverage should have its size ≧0.1 mm³ and its gravity close to the liquid phase. Most solid foods will not leave the stomach until their size is reduced to less than 1 mm³. Meyer et al found that the consistency but not the shape significantly affects gastric emptying. Soft particles are emptied significantly faster than their identically shaped hard counterparts (Gut, 1989, 30, 1526-29). Carbohydrates are emptied faster than protein. Proteins are emptied faster than fat. However, isocaloric concentration of fat, carbohydrate and protein leave the stomach at similar rate. Hyperglycemia (>200mg %) augments other inhibitors of gastric emptying (H. Minami & R. W. McCallum, Gastroenterology, 1984, 86:1592-1606). Plus, aromatic fiber helps clean teeth, e.g., the achene of Siberian cockle bur (xamthium sibiricum), tea, cilantro root, wood fiber. The object of the beverage is to use high consistency mixed solid with liquid to retard the gastric emptying time on a horizontal axis and to increase the contrast among flavors in a vertical depth and broadness.

The water insoluble solid can be a ball having a gas cavity, a sponge-like egg protein or cheese ball, a ball having a nut inclusion, whole grain or bean, small pieces of vegetable, fruit or even ham, a lipid ball, or any edible solid at any shape, which is able to pass a straw smoothly, e.g., stars, fish, flowers, fruit, sweet heart, macroni, or water drop. The water insoluble solid should have gravity close to the liquid so that it can float and be easily sucked into a straw by a small sucking force. For example, a gelatin/fiber ball has a smooth surface. Plastic flexibility gives a person's mouth a smooth touch and makes a person like to hold it for a while. Nevertheless, conventional marshmallow contains too much air and is too soft/light to pass the edge of a straw. Therefore, the gravity and consistency of the solid ball should be adjusted accordingly. Adding fiber will increase the texture and chewing pleasure. Gas whipping is for reducing the gravity of the ball and for increasing the plastic character. The best solid for the beverage should be tender, hard, chewable and stable. Nuts are not used directly because a large force is required to suck them into a straw, which can cause chocking if the person swallows and talks at same time.

Clearly, the solid phase in the product must be edible, have a pleasant appearance, and be small enough to pass through a straw so that consumers do not have to increase the sucking force, which may increase the possibility of inspiring a foreign body. Whole peanut is not used because it has been the most common foreign body to be inspired into the trachea in children under 5 years of age.

Furthermore, the solid can be a mixed ball of water-soluble material and fiber coated by water insoluble material. The solid can also be tofu and cheese mixed with small pieces of vegetable, fruit and bran, e.g. seaweed, yam, taro. The solid can further be air whipped to form a sponge-liked ball. For example, whipped and aerated cheese ball is light and tender. The gas inside the gelatin ball may have a pleasant smell as well. The water stable materials can be selected from sea-living organism and plant, butter, dairy, poultry, meat, gum, vegetable, e.g., cucumber, parsley, carrot, turnip, tofu, fruit, chocolate, wheat bran, bean, grain, e.g., barley, wheat, rice, millet, tapioca, spirulina, phycocyanin, chlorophyll, chlorella, soy/bean protein precipitation, collagen, gelatin, hydrocolloid, gluten, particularly, egg white, soy, butter, cocoa, buckwheat, partially fermented barley and rice.

Vegetable roots are more resistant to moisture than their leaves. Kelp possesses a delicious taste, grows well on the coast and by nature, does not spoil in water. Solids of high-fat fruits, e.g., cocoa nut and avocado, stand well in liquid. Seasoned and partially dehydrated vegetable is tasty and can be coated by water stable material. Roasted bean and grain has appealing aroma and hard texture, which can be reserved by coating as well. Fresh bean and grain work better for this beverage than dried ones because fresh beans and grains are smoother and tender, and can directly be sucked into a straw. Both soybean and oat reduce cholesterol. Oat can easily pass a straw into a mouth. In addition, plant fiber can be mixed with fat and cheese to form a ball as a solid phase.

The solid of the product may further contain at least one inclusion which is selected from nuts, cooked bean or grain, fruit, flaxseed, sunflower seeds, evening primrose, coin oil, vitamin E or A, milk, soy milk, bean milk, raisin, caramel, cheese, cheesecake, or an ice which is solid status in a storage. The solid can also be coated with water insoluble material. The solid of the product can be shaped into an appearance of ball, star, sweet heart, toy, fish, shrimp, spring, whirl, snack, cloud, fantasy target, water drop, flower, fruit, geometric shape, e.g., lozenge, diamond, sphere, etc.

Taiwan pearl milk tea drink (Paul Par) made of tapioca and starch is a popular Asian drink famous by its starch pearls, which are transparent, plastic, and very chewable. However, it has to be fresh made in restaurant kitchens because the starch peals will melt in the refrigerator and the whole drink will be spoiled over night. Besides, it falls into conventional high sugar area and is not nutritionally balanced for diet. To solve this unsolved “melt” deterioration matter, the invention offer the solid a water stable surface of protein, insoluble plant fiber and fat with even better flavor and texture.

The solid mixture combines plant fiber from dehydrated fruit, vegetable, or fermented grain with protein or fat to enrich the body and prolong the digestive period. Numerous researchers prove indigestive solid with liquid has the longest gastric empty time, followed by high consistency digestive solid with liquid. Since both cold and sour work together to increase the threshold for sweetness whereas warm temperature increases the taste sensitivity and eases inner circulation, it is logical to sugget consuming the beverage in a temperature range from 15° to 45° C.

The chambered solid is prepared through yeast-raising or air whipping. The appearance can be aerated fish slurry ball, or frozen tofu float. Protein clots during heat sterilization, pH treatment, or mineral adding, e.g., MgSO4. Egg coagulates as low as 65° C.-70° C.

5. Balanced & Proportional Nutrition

Stability of body weight requires that energy intake and expenditure be balanced over time. In addition to energy, the body requires at least 9 essential amino acids, 1 fatty acid, 13 vitamins, minerals, trace nutrients, bioactive hormones/factors, e. g., phytoestrogen/antioxidant and 1-1.5 ml water/calorie (Fauci et al, Harrison's Principles of Internal Medicine, 14th edition, p227, McGraw-Hill, 1999). Any essential nutrient can result in side effects if too much are consumed on one occasion. A moderate or suboptimal amount of each nutrient works together to maximum synergistic coaction and to minimum adverse effect. In contrast to previous theory of eating one kind food at one time, this beverage combines multiple nutrients in multiple phases to 3D of nutrition structure, health benefit and flavor development. Warm temperature could bring up more aromatic molecules from deep liquid, making consumers feel full and comfortable. Cold stimuli, e.g., ice, may cause coronary artery spasm. A stomach full of ice water can induce water reflex, bloating, and nausea. Furthermore, it will slow down adjacent venous return from lower abdomen and extremities, which may cause prostate congestion or even heart problems. Naturally, it cannot be wrong to design a beverage close to the natural temperature and nutritional baseline that the body tries hard to maintain. For vulnerable consumers, a warm beverage (35-45° C.) eases the body and appears safe for the providers. Drinking too hot a liquid relates to esophagus cancer in some Asian areas because of constant damaging to the mucous membrane. So, the best temperature to consume this beverage is about 15-45° C. The best storage temperature for the beverage is below 15° C.

The coaction of food ingredients on the body extends the present art beyond the point of sweet and calorie. For example, broccoli, greens, tea and coffee may used to help reduce asthma episodes. Feeding antigen can cause an antigen-specific reduction in many types of immune responses, including antibody production, delayed hypersensitivity, T cell proliferation or the generation of cytotoxic T lymphocytes (E Blanas et al, Induction of autoimmune diabetes by oral administration of autoantigen, Science, 274(5293):1707-9, December 1996). Milk contains most of the essential nutrients babies need, e.g., protein, carbohydrate, minerals, fat, and Vitamin B, A, especially V_{E}, which is different and superior to plant source. Mother's milk contains secretive Ig A immunoglobulin, which plays a role in protecting the infant from infection. Mongolia horse milk can make delicious fermented drink. Yogurt milk may increase immune globulin and reduces breast cancer. Hopefully, more immunity from cow/house milk or chicken broth could be added to fight diseases. However, overtaking milk may cause an accumulation of semigalactose, which can be accumulated in the lens and aggravate cataract and kidney problems. Above all, applicant is not intending to replace all milk fat with vegetable fat, because experiments showed that the rat who took only vegetable oil instead of saturated fat had more coronary artery disease than the rat who took only saturated fat. Both extremities should be avoided so that the blood cholesterol and LDL can be reduced and HDL can be maintained. Milk has high calcium content, which can form an insoluble deposit when meeting high oxalate food, e.g., spinach and bamboo shoot. Heating is used at a minimum to reduce unwanted consequence, e.g., sugar binding alanine to form a difficult absorbable compound and lose heat liable nutrients. Deep-freezing is limited because some vegetable nutrients may be destroyed, e.g. Chinese yam may lose its nutrients under 10° C. An increased consumption temperature of 10-20° C. seems safe for most nutrients and gentle to consumers with angina and prostate problems. Adding present beverage into traditional drink is a convenient method of making the beverage. For example, mix soup with root beer, mix herb beverage with soymilk or milk, mix fast fermented grain with fruit juice and martini, mix bamboo or lotus leaf with soft drink, mix orange peeling with broth. In addition, flower and herb go well with rice soup and clear broth soup. Since all bean, vegetable and milk have the lowest glycemia index, their combination used in the invention is expected to result in a smooth glucose response. Plus, fibers from plant cell have shock absorbing benefit on glucose control, such as pectin may increase digestion up to 12 hours, and may reduce cholesterol, such as from 400 mg % to half (200 mg %). Sugar (water soluble monosaccharides or disaccharides) and simple carbohydrate (easy digestible, e.g., starch, white bread) have the highest glycemic index, working together with protein to promote early glucose and insulin secretion release. At least 30% of total energy source in the beverage should be complex carbohydrate, preferably, within their botanic envelope and cell wall. The natural vitamin e. g., B, C, E, and mineral e.g., magnesium, chromium, zinc cooperate with the high fiber/complex carbohydrate/nutrient and low sugar/acid content in the beverage to promote a favorable coaction toward normalizing substance metabolism with delicious flavor.

Sugar has glycemia index 100 with close second of refined flour and starch about 90, which is used for immediate blood sugar release and energy supply. High sweet sugar/fat food with satiety life style has been strongly related to the increased population of obesity in the country. A large amount of sugar actually accelerates glucose intolerance and early diabetes. Proper protein intake promotes gluconeogenesis, builds up body structure, increases immunity, liberates cholecystokinin, and slows gastric emptying. Dipeptides are as almost twice effective. Tryptophan is the most potent amino acid in slowing gastric emptying. However, high protein intake can promote hyperinsulinemia, early maturation and aging, especially when growth hormone is used. Free amino acids are constantly breakdown (catabolism) and then reutilized to rebuild the body protein (anabolism). When adequate amount of carbohydrate are present in this product, the amount of protein converted to energy will be decreased. Fat plays important function including the activity of immune cells, neuron transmission, hormone regulation, fat storage etc. 60% by weigh of the brain is fat. However, high fat content in the blood stream could directly deposit in the blood vessels and adipose tissue. The worst combination is a large amount of sugar in a cold acidic water accompanied by high saturated fat foods. Acid accelerates the fat absorption and decreases the sweet flavor and therefore more sugar has to be added to reach the sweet threshold. The body needs physiologic amount for each nutrient, but it does not simply mean the higher, the better for any individual nutrient. For example, too much fiber could cause malabsorption and torsion of sigmoid intestine. Every food component has its advantage and disadvantage and must work together to approach an optimal health function. Furthermore, cold drink increases venous stasis and reduces the sensitivity of taste and consequently less sensory satisfaction is resulted and more sweet is craved. Adults over 50 years of age may have taste sense reduced, which also accelerates their chance of glucose intolerance. People do not recognize the problem, because it happens in everybody's life almost like a normal rut.

BEVERAGE PHASES, PROCESS, NUTRITION, & FLAVOR

| Phases | Air | Solid | Liquid | Process | Nutrition | Flavor |
|---|---|---|---|---|---|---|
| Present | Smell | Fiber, fat, | Sugar/mineral < 300 | Fermentation | Natural & | Natural |
| Beverage | | & protein | mOsm | 1 day | Balanced | Aroma |
| | | Cell wall | Alcohol: 0-3% | | Botanic | Amino |
| | | Granule | Chemical: 0-1% | | integrity | acid |
| | | envelope | | | reserved | Wine |
| Soft Drink | CO₂ | No | Sugar, Citrate, | Hours | Chemicals | Fruit |
| | | | Mannitol, Vanilla, | | Not balanced | Sweet |
| | | | Caramel | | | Sour |
| Cider | CO₂ | No | Fruit juice | Fermentation | Natural | Fruit |
| | | | No alcohol | 28 days | But not | Sweet |
| | | | | | balanced | Sour |
| Soup | No | ± | Starch | Hours | Natural | Salty |
| | | | Vegetable | | But not | Amino |
| | | | Meat/Seafood | | balanced | acid |
| | | | Natural | | | |
| Cocktail | ± | No | Lemon, citrus, | Fresh made | Not balanced | Fruit |
| Mixer | | | malic acid, certified | | | Sweet |
| (Apple | | | colors, 0.1% Na | | | Sour |
| Sour)* | | | benzoate, ± whisky | | | Liquor |
| Paul Bao | No | Soluble | Sugar ± | Fresh made | Not balanced | Sweet |
| (Pearl Milk) | | soft | milk, fruit, tea | in kitchen | | Sour |
| | | starch | | | | |
| | | ball | | | | |
| Beer | CO₂ | No | Alcohol 3-6% | Fermentation | Yeast, VB, | Hop |
| | | | | 7 d-4 months | malt, sugar | Beer |
| Wine | No | No | Alcohol 8-12% | 1 year | Bioactive | Wine, |
| | | | | | agents, Grape | Grape |
| | | | | | | Sugar |

ANALYSIS OF BEVERAGE COMPOSITIONS

| Edible Component | Benefit When Taking Properly | Avoid Adverse Effects |
|---|---|---|
| Protein | Delicious flavor | Kidney excretion/overload |
| | Gluconeogenesis | High purine may relate to gout |
| | Body structure | Early maturation or aging progression |
| Fat | Creamy pleasure, not↑ insulin | Artery deposit |
| | Satiety, stop eating, delay food | ↑ Adipose tissue/insulin resistance |
| | absorption | Hyperlipedemia |
| | Cell membrane, neuron, storage | Gall bladder problem |
| | Hormone regulation | |
| Carbohydrate | Main energy source | Need insulin for metabolism |
| | Big insulin stimulator | May accelerate glucose intolerance |
| | | DrowsinESS, bonking |
| Sweet sugar | Flavor, Quick energy & insulin | Blood glucose frustration |
| | secretion release | Teeth caries, sugar craving |
| | | Warn: lead tastes sweet |
| Aroma | Flavor, happy mood, immune | Nitrate |
| | booster, preservative, mouth fresh, | |
| | anti-bacteria, essential oil | |
| Bean | High fiber, low glycemic index | Rawbean: hemaglutinins (lectins), trypsin |
| | | inhibitor, bloating |
| Grain | Calorie/fiber/vitamin supply | Refined grain have high glycemic |
| | Glutinous rice quenches | index, & lose vitamins/Mg/nutrients |
| | thirst/eating urge | White bread GI ≅ 86 |
| | Fermented rice/millet has aroma | |
| Brewed barley | Rich vitamins, tonic | Need fruit to cover its order |
| Beer yeast | Rich vitamins, Quench thirst | |
| Vegetable | Satiety, bioactive agents | Low protein/fat, high volume |
| | High fiber/mineral/vitamin | Need meat/protein flavor |
| Water | Body structure, metabolism | Water retention → edema, weight gain, |
| | Fluid balance, toxin clearance | hypertension. Dehydration relates to |
| | | myocardial infarction |
| Mineral | Electrolyte balance, metabolism | Na accumulation → Hypertension, edema |
| | Body structure & cell activity | Hyperkalemia→ Hart arrhythmia |
| Wine | Aroma | Liver damage when taken >20 g/d |
| | Cardiovascular health | Alcohol dependence, Memory lose |
| Beer | Quench thirst, tonic | Beer belly, water reflex |
| Vitamin | Important enzymes | Overdose → adverse effect, urine waste |
| | | Fat soluble vitamin accumulation → toxin |
| Edible herb | Aroma, flavor | Avoid using large amount |
| | Bioactive factors enhance health | |
| Gelatin | Hold volume & shape | Bloating |
| Fiber | Flatten postgrandial glucose | Block nutrient absorption |
| | response, ↓ hypertension, | Bloating, occasionally block intestine if |
| | ↓ gallstones, ↓ constipation | eaten without water |

PROVIDING & USING AMINO ACIDS

| Essential | | Contraindication or | |
|---|---|---|---|
| Amino Acids | Benefit When Taking Properly | Synergetic Coaction | Deficiency |
| Arginine | Stimulate human growth hormone | Avoid use with herpes, | Infertility in males |
| | & immune defense | tumor, or schizophrenia | Premature aging |
| | ↑ Endothelium density/wound | Enhanced virus replication | Overweight |
| | healing after myocardium | unless adequate lysine also | |
| | infarction | present** | |
| | Involved in glucose tolerance | | |
| | factor/insulin production | | |
| | ↑ Fat metabolism | | |
| Lysine | Synthesis carnitine & burn fat | Work with Vc & low | Fatigue |
| | ↓ Arteriosclerosis | arginine to fight virus | Vision disturbance |
| | ↑ Antibodies & reduce herpes | | Increased excretion |
| | | | of calcium/kidney |
| | | | stone |
| Phenylalanine | Precursor of tyrosine, dopamine, | Avoid use in hyper- | Tyrosine deficiency/ |
| | norepinephrine and epinephrine | phenylalaninemia | Vitiligo |
| | ↑ Cholescystokinin/satiety/ | Avoid use with | Mental retardation |
| | weight control | monoamine oxidase | Depression |
| | Anti-depression, pain control | inhibitor drugs | Weight gain |
| | | Caution in hypertension | |
| Tryptophan | Precursor of serotonin | Caution in pregnancy, | Craving for |
| | Weight control | asthma, lupus | carbohydrate |
| | Pain killer | | Insomnia |
| Leucine, | Branched amino acid group | Low branched amino acid | Crawling skin |
| Isoleucine | Leucine ↓ Parkinson's disease | diet for maple syrup urine | Hallucination |
| Valine | D-leucine enhances endorphins | disease | Chronic sickness |
| | pain killer | | |
| Methionine | Antioxidant: ↓ free radical | Assisted by Vitamin B6 | Hair loss |
| | damage, aging, cancer | | Fat liver |
| | Detoxify heavy metals** | | Arteriosclerosis |
| | ↑ Bile salt | | |
| Carnitine | ↓ Triglyceride levels | Adverse effect: | Infertility |
| | Burn fat | gastrointestinal side | Fatigue |
| | Treat fat liver | effects | |
| | | Kidney overload | |
| Glutamine | Component of glucose tolerance | Overload → manic | Cantankerous |
| Glutamic acid | factor, ↑ Memory, ↓ Peptic ulcer | | |
| | ↓ Sugar/carbohydrate craving | | |
| Glutathione | Anti-radiation: ↓ Aging/tumor | | |
| | ↓ Alcohol induced liver damage | | |
| | Neutralize petrocarbon | | |
| | Detoxification | | |
| Glycine | Sweetener | | |
| | Liver detoxifier | | |
| | Form bile acids & nucleic acid | | |
| Cystine | Synthesis insulin | | Liver or kidney |
| | | | stone |
| Ornithine | ↑ Growth hormone | Wound healing | |
| | ↑ Fat metabolism | | |
| | Transport amino acids into cells | | |
| Proline | Wound healing | | |
| | Essential for connective tissue: | | |
| | skin, collagen, muscle | | |

(Dr. Cooker's Lecture, Vascular Medicine, Stanford University, Feb. 22, 2000) (Leon Chaitow, The healing power of amino acids, Thorsons Publishers, England, 1989) (Murray et al, Harper's Biochemistry, Section I, III, Lange Medical Publications, 1993)
*Woodroof & Phillips, Beverages: Carbonated & Noncarbonated, AVI, 1981

Protein required by diabetics for the synthesis of body structure, peptide hormones, antibodies and some neurotransmitters is similar to normal person. However, protein in the present art means extra cooperative effect among ingredients. For example, eye researchers compared diabetic lysine-fed group, diabetic amino acid mixture-fed group, and diabetic control group, and found that the blood sugar levels were lowered from 295 mg % to 99 mg % in lysine-fed group and from 268 mg % to 126 mg % in amino acids mixture-fed group. Only 1 out 6 developed cataract in lysine-fed group and 2 out 6 developed cataract in amino acids mixture-fed group. In diabetic control group, all animals developed cataract in 70-90 days (Sulochana et al, Beneficial effect of lysine and amino acids on cataractogenesis in experimental diabetes through possible antiglycation of lens proteins, Exp Eye Res, 67(5): 597-601, November 1998). Wheat, corn, and rice lack lysine, whereas cow milk (70 mg/g protein) and chicken egg (78 mg/g protein) are among the richest sources of lysine, which works as a functional ingredient and a flavor. Carnitine is essential in transport of fatty acids into the mitochondria to be burned into energy. Plus carnitine improves peripheral vascular function in diabetics (Greco et al, Effect of propiony-L-carnitine in the treatment of diabetic angiopathy: Controlled double blind trial versus placebo, Drugs Exp Clin Res 18, 69-80, 1992). Most Carnitine in the body is synthesized from lysine with the aid of methionine, VC, niacin, V_{B6}, and iron. Milk in the product provides not only the lowest glycemia index working together with a plant mix to ease the glucose intolerance problem but also provides a rich source of essential amino acid-lysine to enhance the utilization of fat. Even though high tech can forfeit many specific nutrients, the consumption of a balanced natural animal-plant mix in regard to essential nutrients, remains the best assurance of an adequate energy intake and utilization. However, it is of interest that bovine beta casein has sequence homologies with beta cell of human pancreas and early consumption of cow's milk may trigger anti-beta casein immune response and insulin-dependent diabetes (Cavallo et al, Cell-mediated immune response to beta casein in recent-onset insulin-dependent diabetes: implications for disease pathogenesis, The Lancet, 348(9032): 926-928, October 1996). Even though insulin-dependent-diabetes is only 10% of all diabetes, it seems safe to use other protein instead of early consumption of beta casein. Similarly, it sounds safer for susceptive consumers having a diabetes type II family tendency to consume no gluten food in early childhood.

Potassium and magnesium rich in plants are useful in lowering blood pressure, angina, kidney stone and the risk of stroke. Complex carbohydrates should be the main fuel including diabetics but not water soluble, quick absorbable, small molecular sugar. Insufficient carbohydrate intake may result in ketosis, excessive breakdown of muscle and tissue protein (wasting), and dehydration. Simpson et al observed that high carbohydrate (60%) modified fat diet resulted in a fall in basal plasma glucose concentration and percentage of glycosylated hemoglobin. Salmeron et al found that high glycemic load and low fiber food increases the risk of non-insulin dependent diabetes. Plus, sweeteners may decrease white blood cell's activity and thus, the total sweeteners in this beverage are restricted to less than 7 wt %. Also, high salt food could decrease immune capacity of respiratory tract and increase the likelihood of catching influenza.

6. Sweeteners

No doubt sweet flavor has been the landmark of conventional beverages. However, sweet taste can only be felt at the of anterior tip of the tongue, whereas plain flavor, protein taste, fat cream, chewing texture, aroma, bitterness, alcohol penetration, and mild salt offer much allure, reach broader and deeper, and last longer. That can be the reason why many consumers feel they are missing something after consuming a sweet drink, because the rest of the tongue and the body are still searching.

Chemicals that cause sweet taste includes sugars, glycols, alcohol's, aldehydes, acetones, amides, esters, some amino acids, e. g., glycine, sulfuric acids, halognated acids, and inorganic salts of lead and beryllium. About 15-30% of people exhibit taste problems. Plus, some diabetics have peripheral sensory nerve damage and may not be sensitive to sugar stimuli, which drives them to take more sugar. Usually normal people can feel sweet at the concentration about 2% sugar but diabetics may not feel sweet under 4%. Even though the taste sense of adults over 50 years of age may start to decline, many healthy seniors could still enjoy excellent taste sense after 70 years of age. Also, taste preference often changes in accord with the need of the body for certain specific substance. Sugar craving and eating urgency are likely related to insulin resistance or glucose intolerance, which can increase the threshold of sweet sense above normal range. Instead of increasing the strength of stimuli until the body can no longer feel it, a resting interval or a change of different taste, e.g., a bitter or plain flavor, may work better. Hyperglycemia causes damage to small caliber blood vessels and peripheral nerves, greatly increasing the risk of heart attack, stoke, blindness, amputation, and kidney failure (Wardlaw & Insel: Perspectives in Nutrition, 1996, Mosby). 2,631 adults epidemiological study shows that maintaining an optimal glucose levels without the use of insulin was able to reduce the incidence of retinopathy among Non-Insulin-Dependent Diabetics from 71% to 39% (Leibowitz H M et al., Surv. Ophthalmol. 24, Suppl.:335-610, 1980). In Diabetic control and complications trial, intensive glycemia control therapy reduced the development and progression of all complication by approximately 50% (N Eng. J. Med, 329:977-86, 1993)). Sugar, e.g., monosaccharide and disaccharide, is highly water-soluble small particles and influences the body Osm along with Na. Sucrose contains one glucose and one fructose, that combination brings up a more full round sweet sense than single sugar, e.g., glucose, which feels sharp and thin in the beginning and sour pucker at the end. Besides, glucose lacks the gluconeogenesis effect, making its glucose levels fall down very quickly and making hunger return immediately. A small amount of salt, bitter, pungency, or sour will enrich and deepen the sweet flavor. Un-uniform flavors, e.g., an inclusion inside the solid made of almond, sunflower, beef jelly, ham, dehydrated napa, or vegetable, will not only contrast the sweet to a maximum degree but also these rich flavors stimulate broader sensory pass ways and brain fields, and therefore, less amount of food is craved.

Experiments have shown that endothelium cells shrink in a hypersonic solution and open the gap between endothelium cells, which will cause small molecular material leakage from the vessel. In contrast, hypotonic solution will make the cell swell. When it is reaches its maximal flexibility, the cell will burst and can never return back to its previous condition. Even if the cell and gap might recover after the hypertonic stress, the leakage and the damage may not be able to recover in diabetics because of their vulnerable vessels. When their gaps between endothelium cells are opened, the previous vascular leakage and consequent damage can be accelerated. The body needs to keep the inner environment in an isotonic range of 275-295 mOsm. 5% glucose or 0.9% NaCL solution is usually considered as an isotonic solution when compared to the body fluid consistent value. Furthermore, normal blood sugar is less than 140 mg % (0.14%). 10% glucose could be a physical force of driving gradients by 70 times, which the body does not desire. Hypertonic solutions made of high water soluble un-absorbable materials, e.g., 25% sorbitol, has been used for brain edema to retrieve water out of the edema area, causing relative dehydration and urination so that the edema of brain cells can be reduced. Oral hypertonic solution is less powerful than intravascular injection or perfusion, but still has mild urination and dehydration effects, which may accelerate osmolity frustration and thirst. It is wise to avoid hypertonic frustration, vessel leakage, bleeding, or even neovascularization before irreversible damage could occur, so that people can live under normal healthy conditions until all their compensation capacity is exhausted at a physiologic longevity.

The composition of the beverage takes account, not only of the function of each ingredient but also of the interaction of ingredients. For example, fructose is 173% as sweet as sucrose and can be quickly absorbed within 5-15 minutes, producing a smaller effect on the blood glucose level than sucrose. Both fructose and alcohol require liver for their metabolism but not insulin, forming a quick, direct energy release. Fructose results in either no rise or only a very small rise in insulin concentration in normal subjects whereas it is up to 30% as potent as glucose in stimulating insulin secretion in type 2 diabetics (Nuttall & Gannon, Diabetic Care, 14:824-838, 1991, Nuttall et al, Metabolism, 41:510-517, 1992). However, a high fructose diet (20% by calories) could be a heavy load on the liver and can increase cholesterol (6.9% higher), LDL (10.9% higher) as well as TG. Combined sweeteners round the taste in lesser doses. Differentiated from two prior extremities: some previous beverages have more than 70% by calorie sugar and some dietary beverages have no sugar, the applicant intends to use small amount sugar to release insulin secretion suppression, and to avoid hypoglycemia. Plus, honey alleviates the polydipsia symptom, blocks sugar craving and eating urges, and smoothes the glycemia response. As a result, most people can safely enjoy this beverage. Protein is equally as potent as glucose in stimulating insulin secretion in diabetics. The C-peptide area response to fructose with protein was smaller compared with the area response to glucose. Both glucagon and glucose response to fructose plus protein were less than the sum of individuals. As the most, glucose and protein interact synergistically to stimulate insulin secretion in people with type II diabetes and is additive in normal people (Krezowski et al., Am J Clin Nutr 44:847-856, 1986). Therefore, the combination of fructose and protein are used as an early energy releaser and hunger soother as well as gluconeogenesis promoter to prevent plasma glucose levels becoming too low. Proportional protein works as an early insulin secretion inducer and later glycemia keeper. When main complex carbohydrates release their glucose into the blood, there has been enough insulin to utilize it. The main energy supply is complex carbohydrate having big molecule, branches, and digestive resistant granules under the envelope or cell wall, not sweeteners or simple sugar.

Isomalt is a sweet disaccharide alcohol, which has no glycemia effect when consumed as a pure compound. Gee J M et al compared “The effects of conventional sucrose-based, fructose-based and isomalt based chocolates on postprandial metabolism in non-insulin-dependent diabetes” and found the area under the glycemia curve for isomalt chocolate was 36% smaller than that for conventional chocolate, consistent with the lower glycaemia effect. Isomalt appears to be a palatable alternative sweetener capable of reducing the glycaemia effect when used in confectionery (European J of Clinical Nutrition, 45(11):561-6, 1991).

Aspartame contains 2 amino acids and 1 methanol and is 180 times sweeter than glucose. Ingestion of 50 mg aspartame/kg body wt/day is 1% of the amount shown in animals and humans to have no toxic effects (FDA and ADA Position Statement 1987). However, since methanol is an optic toxic, present art would not use it for consumers with diabetic retinopathy. Acesulfame K is 400 times sweeter than glucose and its acceptable daily intake (ADI) is 15 mg/kg. The optional ratio of sweetness between natural and no caloric is about 1:10. The goal of the present art is to offer a natural healthy beverage which has a novel fresh palpability close to or superior to conventional products, with at least no conflict among ingredients and drinking related conditions. Excess forfeit use of vitamin or mineral is avoided to reduce possible negative interaction. All honey, fructose, glucose, isomalt and simple sugars are restricted to no more than 10% by calorie. All quick absorbed simple carbohydrate (refined rice/wheat, starch, sugar) is restricted to less than 15% by total weight. Refined rice/wheat flower is limited because of their high glycemia index and overwhelming loss of V_{B}, Mg, and nutritional factors. Alcohol is restricted to less than 3%, mainly from wine or fermented grain, e.g., rice. Unlike many wine need to add sugar or honey, the rice fermentation for the present art will produce a sweet taste and a mild wine flavor but it is not a liquor. Cooked rice is mixed with the powder of sweet rice wine yeast when it is cool down to about 45° C. The second day, the rice will become very sweet and more tender and will be flooded by a clear wine-like liquid and aromatic gas produced by the fermentation.

Stevia is a famous herb used for diabetes in Brazil. Plus, it is as 3 times sweet as sugar and therefore is used to replace aspartame in the present art for these two purposes. People are more sensitive to insulin when consuming high carbohydrate as opposed to high fat diets because they have increased number of insulin receptors. Of greater importance is the enhanced intracellular glucose metabolism associated with high carbohydrate diets. Inositol is a 6-carbon sugar similar to glucose. Diabetics have an intracellular deficiency of inositol, especially in the nerves and reports suggest that the secondary complications of diabetes can be ameliorated by dietary inositol supplement (C. Berdanier, Is inositol an essential nutrient? Nutrition Today 27(2):22, 1992).

Current knowledge concerning sugar cataract in diabetics as a glucose conversion in the sorbitol pathway and therefore, aldose reductase inhibitors are used to reduce such cataract. Besides glucose, ascorbate (Vc) emerged as a potential precursor of advanced glycation in cataract, owing to the high concentration present in human lens. Thus, sorbitol is reduced to a minimum and Vc is used in a moderate amount.

7. Providing & Using Alcohol & Fast Fermentation

All alcohol ingredients in the product are edible alcohol. Alcohol is used for its cardiovascular benefit, tonic, mood booster, aroma, sterilization, and quick energy supply (7 calories/g) up to 3% by weight to avoid alcohol hepatitis. For consumers having liver problems or on abstinence of alcohol, fructose, inositol, or glycine is offered. Differentiated from the traditional process, e.g., barley for beer, grape for wine, fruit for cider, grain for liquor, or bean for miso, this fermentation is obtained just after the flavor comes out and before the materials lose their tenderness. The alcohol component in the beverage will ease tension and dissolvable nutrients will be swiftly and smoothly absorbed when other food will not “stay down” (Beer & Brewing in American, 1949, Morris Weeks, Jr, U.S. Brewers Foundation).

Although this beverage can be made by mixing the liquid, solid, and air with wine or beer, the applicant prefers to use a sweet rice wine or beer like yeast to initiate the process for its pleasant flavor as aroma and its intact tender grain as solid. Differentiated from beer, cider, wine and liquor, which take at least 7 days, 28 days, 1 year, and 1 year respectively, the sweet rice yeast produces fermentation within 1 day. During conventional fermentation, the carbohydrate is converted into almost exactly equal parts of ethyl alcohol and CO₂ with very light amounts of glycerol and succinic acid. In malt beers, 20-50 wt % corn and cane sugars have been used to feed the yeast, enabling it to produce more CO₂ and boost alcoholic strength. However, the sugar will add cider flavor on the top of malt flavor and drive away the beer taste, which teaches away from the present art. The rice yeast of the product does not need additional sugar, instead, it produces strong sweeteners, water, CO₂, aroma, and very light amount of alcohol, which combines the result of alcohol fermentation and hydrolysis. Small amount of aromatic material, e.g., aldehydes, acetals, esters, higher alcohol, glycol can add significant flavor on the beverage. Heating will stop the fermentation so that the grains will still be tender and tasty. Unlike beer yeast require a temperature range from 50° F. to 65° F.; this fast rice yeast needs approximately from 60° F. to 105° F. The present fermentation is faster due to the warmer temperature, and can be matured even within 20 hours. Furthermore, the present fermentation degree is less than 50% for preserving the integrity of grains and beans for storage and chewing. Facilitating the coagulation of unstable malt protein and the sedimentation of yeast are not necessary. Since the products are very sweet, it is not necessary to add sugar as ale or wine does. If the yeast is not killed during the process, the fermentation will be slow down in cold storage. Therefore, the time for shelf storage is prolonged and more flavors are developed.

Hops and aromatic material used in the beverage is soaked in liquor or wine to reduce bacteria infection and to avoid aromatic oil and alpha acid loss. Unlike typical wine chocolate candy, this alcohol is frozen to form one or many solid core(s). Then, rotate such alcohol solid(s) for increasable picking up a powder made of protein, fat, starch, gum, and adhesive material to form a ball or many balls.

8. Providing & Using Botatic Integrity

Since the diameter of granules under the envelope of bean, e.g., soybean, is about 15-25μ, the applicant is intending to achieve a maximum gelatinizing/swell (tenderness) without over grinding or breaking all granular envelopes so that these anti-digestive granules can be preserved. Soaking and boiling have less chance than blending concerns in breaking these digestive resistant granules. Partial drying before the dipping or immersing process will pick up more small molecular milk and flavor without exceeding the Osm allowance so that the granular walls can be maintained through Osm frustration during the process.

The seed of Job's tears has a delicate flavor and may reduce blood sugar, blood pressure and the risk of sarcoma and cervical cancer. Unlike wheat or rice flour, oat and buckwheat have very low glycemic index and can reduce hyperglycemia. Both epidemic statistics and experience show buckwheat consumption significantly reduces diabetic rate in Asia. Plus, buckwheat has rich taste and high protein superior to wheat. Keeping the integrity of grain and bean could be used as native solid phase to prevent numerous nutrients loss. Preferably, materials in the beverage are organic grain, bean, vegetable, egg, and milk without the use of chemical pesticides and growth hormones.

9. Providing & Using Natural Vitamins Through Food Combination

The metabolism of carbohydrate, protein, and fat needs coenzymes, especially, V_{B1}, B₆, and assistant agents, e.g., zinc, chromium, and hormone, e.g., interaction of insulin and glucagon axis. Thiamin pyrophosphate is an important coenzyme in carbohydrate oxidation and citric acid cycle. Without the assistance of V_{B1}, carbohydrate cannot burn completely and the side products from in-complete burn make people feel tired. High carbohydrate diet requires more thiamin than a diet rich in fats because only one step of fat metabolism requires this coenzyme but three steps of carbohydrate metabolism need the coenzyme. Tannic acid, coffee, and polyphenols are powerful inhibitors of thiamin. Tea inactive V_{B1} due to the formation of tannin-thiamin complex. Alcohol drinks will destroy V_{B1}. Large amount of soda can also reduce thiamin levels. Severe thiamin deficiency relates to Wernicke's encephalopathy and cerebral beriberi (Acute onset of mental confusion, opthalmoplegia, gait ataxia, etc). Riboflavin participates in the synthesis of glycogen, in forming red blood cells, in utilizing fat and helps thyroid hormone in regulating enzyme activity. Although all food of animal and plant origins contains thiamin (V_{B1}) and riboflavin (V_{B2}), the richest thiamin store is in the germ and outer coast of seeds, most of which is lost during milling and refining. Other rich V_{B1} food includes yeast, soybeans, brown rice, sunflower seeds, and peanuts. The best natural source of V_{B2} is yeast and milk. Using whole grain and yeast will reduce above nutrient loss. Excess intake of water-soluble vitamin is rapidly excreted in the urine. Accumulation of fat-soluble vitamin causes toxin. Water-soluble vitamin can be utilized better when taken with food. Fat-soluble vitamin is absorbed better when taken with food containing fat. Above all, food and vitamin need each other and therefore, a balanced food rich in such vitamins is irreplaceable.

Biotin (V_{B3}) helps utilizing fats and amino acids, participating to four CoA carboxylases in the metabolism system. Its deficiency may cause severe exforliative dermatitis alopecia and myalgia. Vegetable alters intestinal bacterial flora that promotes the synthesis and absorption of biotin. Avidin in raw egg white reduces biotin absorption. Egg, soy protein, seafood, or fat in the beverage is heated to from shells to protect its inclusions not being melt by water. Highest biotin is found in yeast, beef liver, soy flour, bean, and rice, which can be mixed with fat or protein to form a water insoluble solid.

Pyridoxine (V_{B6}) contributes an essential role in all aminotransferases, amino acid decarboxylation and glycogen phosphorylase synthesis. Its requirement is closely related to the amount of protein intake and is satisfied at the level of 0.02 mg per gram of protein. (V M Sardesai, Introduction to Clinical Nutrition, 1998, Marcell Dekker, Inc). Yeast, sunflower seeds, wheat germ, soybean, nuts, and legumes in the product provide good natural sources of V_{B6} for enhancing the metabolism of protein and carbohydrate.

Folic acid is essential for DNA synthesis and its deficiency can cause severe anemia, glossitis, gastrointestinal impaired digestion/absorption, or thrombocytopenia in malnutrition, celiac disease, tropical spruce, proximal bowel resection, cancer chemotherapy, pregnancy, infant and adolescence. Highest folic acid exists in yeast, fresh green leafy vegetables, asparagus, and lettuce, and therefore, they are included in the product to improve protein synthesis.

Niacin exists in all living cells as coenzymes NAD and NADP for accepting or releasing hydrogen and therefore is essential in the metabolism of glucose, fat, and steroids. Plus, niacin is a part of glucose tolerance factor, which enhances insulin response. The best source for niacin also is in the outer husks of grains and therefore, unrefined grain is preferred. Furthermore, legume and peanuts are rich in niacin and could be included in the solid mix in the beverage as a natural source of function food.

Pantothenic acid is a main component of coenzyme A, which plays an essential role in the metabolism of carbohydrate, fat and protein plus fatty acid activation, immune antibody and adrenal corticoid synthesis. Yeast and eggs are among the richest sources. Moderate amounts of pantothenic acid presents in milk, broccoli, molasses, avocados and sweet potatoes. Intestinal flora can synthesize the vitamin as well. Since diabetes is mainly a metabolism disease, ample supply of V_{B}, C group in the product is expected to improve the long term metabolism of carbohydrate, protein, fat, and well-being.

Cyanocobalamin (V_{B12}) deficiency causes severe anemia and damage to the myelin sheath of nerve in vegetarians. Unlike other V_{B} can be obtained from yeast, vegetable, bean and grain, V_{B12} is not present in fruits, vegetables, or grains, and therefore eggs, milk and seaweed in this beverage offer a good supply of V_{B12} to reduce nerve damage and enhance protein synthesis.

To summarize, vitamin B group are used as the following:

| Vitamin | RDA* | Rich Source: mg/100 edible portion | Effect on Human Health |
|---|---|---|---|
| VB1 | 1- | Yeast: 14-15, wheat germ: 2, brown | Assistant main energy metabolism- |
| | 1.6 mg | rice, sunflower seeds: 1.96, pine | Carbohydrate utilization |
| | | nut: 1.84, soybean: 1.10, wheat | Maintain nerve function against diabetic |
| | | bran, bean, millet, buckwheat, | damage |
| | | oatmeal. Alcohol inhibits the | Deficiency→beriberi, impaired mental |
| | | absorption of VB group | status, sugar crave, irritation, anxiety |
| VB2 | 1.2- | Yeast: 4-5, liver: 2.7, almond: 0.92, | Assist energy metabolism-Protein |
| | 1.8 mg | wheat germ: 0.68, wild rice: 0.63, | utilization |
| | | mushroom: 0.46, millet: 0.38, | ↑glutathione against free-radial damage |
| | | carrot: soybean | and esophageal cancer |
| | | | Deficiency→cataract, red eye lid, mucous |
| | | | ulcer |
| VB3 | 30- | Yeast: 200, beef liver: 96, | ↑insulin sensitivity |
| Biotin | 300 mg | soybeans: 61, rice: 57-60, egg | Enhance the utilization of glucose, fat, and |
| | | white: !!! | amino acids |
| | | Walnut: 37, barley: 31, oatmeal: 24, | Vegetable diet ↑ gut bacteria to synthesis |
| | | peas: 18-21, cauliflower: 17, | biotin |
| | | lentils: 13 | |
| VB5 | 4- | Yeast: 12, liver: 8, peanuts: 2.8, | Utilize fats and carbohydrates |
| Pantothenic | 7 mg | mushroom/split pea/soybean: 2.0 | For adrenal hormones & red blood cells |
| Acid | | | Lower blood cholesterol and triglyceride |
| | | | Cooperatively coact with other VB, CoQ10 |
| | | | & carnitine |
| VB6 | 1.5- | Yeast: 2.5-3.0, sunflower | ↓ glycosylation of protein |
| Pyridoxine | 2.2 mg | seed: 1.25, Wheat germ: 1.15, | Optimize the body enzyme system |
| | | soybean: 0.81, walnut: 0.73, lentil: | Help protein utilization & body structure |
| | | 0.6, bean, rice | Maintain hormone balance |
| | | | Deficiency→ kidney stone, nausea/ |
| | | | vomiting during pregnancy, osteoporosis, |
| | | | low immune, |
| Niacin | 13- | Yeast: 38-44, rice bran: 28-30, | Optimize sugar/lipid metabolic control |
| | 20 mg | wheat bran: 21, seasame: 5.4, | Lowering blood cholesterol/triglyceride |
| | | sunflower seed: 5.4, brown rice: 4.7, | Lowering intermittent claudication |
| | | pine nut: 4.5, whole buckwheat: 4.4 | Reduce blood sugar in diabetes |
| | | | Deficiency→pellagra: dermatitis, |
| | | | dementia, diarrhea |
| VB12 | 2- | Lamb liver: 104, clams: 98, beef | Synthesis DNA, red blood cells and myelin |
| Cobalamin | 2.1 mg | liver: 80, egg, dried whey: 2.0, | sheath of nerve |
| | | cheese: 1.0, animal sourced food | Prevent pernicious anemia |
| Folic acid | 150- | Yeast: 2022, black-eye peas: 440, | Reduce homocyterine(atherosclerosis, |
| | 280 mcg | rice germ: 430, soy flour: 425, dark | heart attack), osteoporosis & depression |
| | | green leaf vegetable | Supply must include VB12 supplement at |
| | | | the same time Because folic acid can |
| | | | mask VB12 deficiency |
| Choline or | 350 mg- | Beef liver: 532, cucumber: 282, | Help fat metabolism |
| lecithin | 5 g | beef steak: 68, Peanuts: 28, | |
| | | cauliflower: 22 | |
| Inositol | 0.5- | Exist as phytic acid from fiber in | Reduce depression, panic attacks, fat |
| | 2 g | vegetable | stagnation in liver or diabetic neuropathy |
| *For normal people > 11 years old by Recommended Dietary Allowances, 10^{th} Edition, p 115-262, National Academy Press, 1989. (Reddi A et al., Biotin supplementation improves glucose and insulin tolerances in genetically diabetic KK mice, Life Sciences, 42: 1223-1230, 1988) (M. Murray, N.D., Encyclopedia of nutritional supplements, Prima Publishing, 1996) (Giller & Matthews, Natural Prescriptions, p 111-116, Ballantine Books, 1994) (Morrison & Hark, Medical nutrition & | | | |
| #disease, Blackwell science, Inc, 1999) | | | |

As a powerful antioxidant, Vc (L-ascorbic acid) is added to some beverages for reducing the oxidation. Also, Vc reduces nitrates that is carcinogenic, and facilitates the absorption of iron. Research indicated that Vc may inhibit the glycosylation of proteins and slow down the deterioration of diabetic complications (Davie S J et al, Effect of vitamin C on glycosylation of proteins, Diabetes 41:167-73, 1992). Like most antioxidants, Vc is unstable when exposed to the air and heat, e.g., a slice of cantaloupe uncovered in refrigerator can lose ⅓ of its Vc in less than 24 hours. This is one reason why the present beverage uses inert air or aroma instead of the atmospheric air. After saturating the body tissue, excess Vc is excreted in the urine. Plus, an ingestion of big dose Vc can be partially converted to oxalic acid and consequently increase the risk of urinary tract stones. Since human can not synthesis Vc, a modest Vc intake (regular: 60 mg, cigarette smokers: 120 mg) from natural sources with minimum interruption among ingredients is expected to function better than a large dose pill. Also, 0.03-0.05% ascorbic acid or citrate acid, 0.1% H₂SO₃ or lemon juice, 0.9% salt or pH 4.5-7.0 helps protect the color and nutrients of fruits and vegetables. In order for most nutrients to be safe, the heat process for the beverage is preferably around 80-90° C. with the help of vacuum for penetration, or filter for bacteria. Vegetables and fruits are used preferably as solids over slurry so that more nutrients and flavors can be preserved.

10. Providing & Using Fruits & Vegetable as Functional Food

According to a privately funded consumer health advocacy organization, cantaloupe heads the chart as the most nutritious fruit and watermelon comes in at a close second. Cantaloupe is high in provitamin A, Vc and myoinositol, a lipid that relieves anxiety and insomnia and helps prevent hardening of the arteries. Watermelon rind, both the green and white parts, is full of V_{A}, K, zinc, and releases a free-radical scavenger that reverses the peroxide emission dying cells. (Jay Kordich: the Juiceman's power of juicing, 1993, A Time Warner). Pears help normalize the metabolism, improve cardiovascular health, and even the blood pressure. Pears contain a good dose of V_{B1}, ₂, ₃, folate, Vc, P, and Ca. The sweetness of pears is supplied in large part by levulose, a fruit sugar more easily tolerated by diabetics than other sweeteners. Pears contain more pectin than apple, which help prolong the digestion and curb constipation. Hawthorn is used for improving cardiovascular circulation and increasing appetite. Apple reduces diarrhea whereas pear reduces constipation. Mellon and cucumber are more likely to reduce weight while peach is more likely to add weight. Mung bean intends to reduce weight whereas red bean intends to increase weight. Beer yeast provides the richest source of folic acid, V_{B1}, V_{B2} and chromium while makes a novel beer flavored beverage. Unlike high water content fruits that spoil during frost, persimmon and some sea vegetables gain more flavors after freezing. The disadvantage of persimmon is that it is associated with gallbladder stones and constipation, and thus, consumption of a small amount is wise to avoid such adverse effects. Malic acid and vanilla could round the body of the beverage whereas citric acid could bind calcium to decrease the risk of urinary stones and therefore are optional used as a few exceptions among chemicals.

All raw materials are thoroughly washed to remove chemical or fungus contamination. Soaking fruit in an alcohol solution will not only improve microbial stability but also will induce fermentation. Fresh water contains little nitrate. Soft water and snow water make a better beverage. Boiled water used in herb/vegetable beverage has had most chlorine evaporated and therefore more V_{B} will be reserved for optimal energy utilization. More nutrients can be destroyed when the heat is above 50-60° C. continuously.

Fruit and vegetable in the beverage are seasoned and partially dehydrated, e. g., carrot, celery, green onion, parsley, kelp, pears, toasted egg plant, cooked pea/bean/grain. The fruit and vegetable are not used as slurry or juice. Instead, these solid materials are used as solid and shaped into small pieces to be added into the liquid under cool temperature, so that most nutrients are reserved in the manner of sealed cold containers. A minimum refining process is preferred to cut the loss of nutrients. Cooked beans, seeds and grains also float well in a liquid. Dehydrated small vegetable pieces are light and stable for floating. Many vegetables, e.g., cabbage, spinach, water shield, provide natural flavor and delicious taste.

11. Providing & Using Edible Herb Remedy

Differentiated from the typical use of food as a coating or carrier of an herb remedy, the present art combines multiple food ingredients as a functional food to work with optional assistance of an herb remedy. The essential improvement of present art is the cooperation among food compounds and between these food compounds with herb flavor or remedy. The disclosure comprises essential balanced foods in light of the human physiology requirement whereas conventional herb therapy depends on sole herb or extract.

Many edible herbs on the market have a fruit-like flavor and can be easily incorporated into the product to enhance health coaction. For example, ophiopogon root and dendrobium reduce eating urgency, quench thirst, increase satiety, and help the body get back to its physiologic condition. A Dutch doctor found that patients were cured of peptic ulcers by high doses of liquorice extract. Its saponin (glycyrrhizic acid) is about fifty times sweeter than sugar. Liquorice root provides a fresh sweet flavor and acts as a cooperative mediator to bring harmony among various ingredients except one diuretic herb. For example, liquorice works well with red date and float wheat to reduce hot flashes in menopause syndrome. Also liquorice helps neutralizing, reducing poison and liver damage, and quenching thirst, which reduces the drink-eating urgency. Since it is related to fluid retention and may increase blood pressure, it is prudent not to use liquorice in hypertension. In contrast, liquorice could be used in exhaustion, stress or Addison's disease, because liquorice helps the adrenal cortex to produce its own corticosteroids (Penelope Sach, On tea & healthy living, 1995, Allen & Uniwin, Australia). Astragalus root also works as a tonic agent and may reduce sweating, tiredness, and cold intolerance, for which astragaus and zinc work cooperatively. Ginseng can improve hypotension and cold tolerance but worsen hypertension. Cooperative results can be achieved by choosing the herb and food combination.

As a popular antioxidant, evening primrose may help in reducing diabetic complications, cancer, and immune related diseases, e.g. asthma, arthritis, Crohn's disease. Evening primrose or edible herb can be extracted by freezing dry, or directly adding to the liquid or gelatin balls depending on the acceptance of the flavor and coaction on each individual case. Above all, less process is preferred because of nutrient loss, e.g. heating an essential oil, juicing, refining, extract, etc.

12. Nutritional Balanced Food Structure Around Physiological Constant Central Value

The product further adjusts vitamin and mineral into an equivalent of approximately Vc 45-400 mg, V_{B1} 1.0-2.3 mg, V_{B2}. 1.0-2.0 mg, biotin 50-200 ug, V_{B6} 1-10 mg, niacin 8-20 mg, V_{B12} 2-6 ug, folate 50-400 ug, phentothenic acid 4-7 mg, V_{A} 600-1000 ug, V_{E} 7-14 mg, selenium 55-70 ug, chromium 50-200 ug, inositol 10-100 mg, carnitine 1500-4000 mg, zinc 10-15 mg, calcium 500-1,200 mg, magnesium 200-700 mg, Mg/Ca ≧1/2, Ca/P ≧2/1, potassium 2-5.5 g, sodium 0.5-2.4 g, and fluoride 1.5-4.0 mg in 1,500-3,000 calories of product. The vitamin and mineral improve the long-term metabolism of carbohydrate, fat and protein. During high stress, contaminated food and calcium may deprive the magnesium inside the cell and thereafter excess calcium in the blood will enter the cell and worsen arteriosclerosis and hypertension. Thus, magnesium is used for reducing insulin resistant related to hypertension, diabetes, and coronary artery sclerosis. A high dose of single nutrient is not used because negative interaction can be triggered by excess intake.

The product is adjusted into a balanced nutritional distribution, comprising 45-70% by calorie carbohydrate, wherein at least ⅓ of total carbohydrate is complex carbohydrate or digestive resistant granule capable of increasing insulin sensitivity and flattening postgrandial glycemia response; up to 30% by calorie protein or in a quantity capable of improving insulin and gluconeogenesis response, wherein at least ⅓ of said protein is plant protein; up to 30% by calorie fat or in a quantity capable of delaying gastric emptying and producing a satiety, wherein less than half of said fat is derived from saturated fat; fiber 10-37 gram per 2000 calories, a pH in a range of 4.0-7.8. In addition, restricting lower limit of pH can reduce aluminum dissolving because several researches indicate high blood aluminum concentration may relate to memory loss.

Differentiated from Chait et al's teach about “Method for Determining Diet Program Effectiveness” by selecting and dividing patients to two groups, administering diet program to the 1^{st} group and control diet with known beneficial effects on 2^{nd} group, this disclosure is set forth to use physiological coaction of functional food and beverage to help the body attain and maintain its normal value in a physiological field. Such reference is not based on a two-group test but rather is referred to physiological constant value of the human body. Even though there are numerous human species in the world, the normal physiological values have been quiet constant through generations. The present goal is to stay in the physiological field by a physiological method. If the person is out of the normal range, he should be pulled back in a physiological way from a point between the normal center and the present point. Medical management and intervention of a pathological condition is not in the field of present art, because it needs close medical supervision and nutritional specialist. There has to be some other straightforward way to work things out that play a factor on health fitness. For example, many eating and drinking related problem are related to the control of ideal body weight, blood glucose and blood pressure, which should be in physiological field. The majority of diabetics, hyperlipedemia, and hypertension have eating urgency, overweight or constipation, which happened first and once improved, will consequently improve the entire group of related problems. The main reference center is constant physiological value and ideal body weight. Functional food/beverage/drink, art of drinking, art of beverage, and art of eating are an independent art, which provides not only eating and drinking pleasure but also a positive coaction among food ingredients and the way it is made and used. Compared to prior records, the present beverage is the simplest of making and the easiest of using with extended pleasure of self education, taste experience, and health success. The improvement comprises using near normal body fluid composition as the reference and using balanced food structure as a rule to keep each embodiment around such center. No matter how many categories or embodiments for the same principle, the balanced proportion and coaction rule will keep the composition, making and using around the normal/physiological center as eccentric circles. The practice is easy for the skilled in the art once the center and the ruler is set. Furthermore, the body fluid composition has been very constant to be the center among various age groups. Of course, many young customers have the greater capacity to overcome most deviated bias. However, it is a problem for elder consumers with compensation capacity exhausted below 20%. Therefore, extend arm or radius is bigger in youth than elderly. Furthermore, each centric cam should not be deviated beyond the point of maximum compensation allowance and should offer another eccentric cam to balance the deviate tendency, making it easy for the body compensation.

Nothing can be safer to a food and beverage provider to stay within a physiological range so that the body is able to easily handle the intake and stay within physiological range. For example, it is perfectly acceptable to make and use hypertonic solutions as antimicrobial to reserve a food. But it is may not be good choice to use it as beverage for humans, e.g. 20% sugar liquid, which can cause significant hypertonic (Osm) frustration and can be reflected by the change of lens optic index and diuretic effect. This factor accelerates the formation of cataract and glucose intolerance. Naturally, the eye tends to recover in most cases. However, after daily high sugar and hypertonic load, the body may finally run out the compensation and consequently cataract or glucose intolerance is formed. It is well known in the prior art that caffeine, margarine, cocaine, spicy, un-edible herb, pesticide residual, growth hormone, and drugs have adverse effect and have to be protected from improper use. However, many foods can also act or be used as drug. This is not only because many drugs and foods have the same plant antecedence but also because too many good things will break the balance. The disclosure means to provide food standard in a physiological field, which is less likely to lead to a pathological condition at the first place. There are hundreds of ways to make a tasty drink and it is really not necessary to rely on hypertonic stimuli to satisfy this sense organ on the mucous of the anterior tongue. There has never been a law stating that all beverages must be sweet tasting with empty calories or must not comprise protein or fiber. Hypertonic beverages, by nature, increase dehydration and thirsty, and thus, should be excluded. Sour taste does significantly calm the thirsty feeling. However, sour flavor does not solve any dehydration problem. For instance, 15% glucose solution plus multiple salts is more likely to be an osmotic abuse and bacteriostatic agent rather than a tasty relaxing beverage. The characteristics of present art are to use a physiological center with a balanced composition ruler to keep its embodiments around the center as eccentric circles or cams. The maximum extension of bias allowance in the present art is upon youth and living condition. Although over correcting or using the opposite side force can pull a deviated condition back to physiological ground, the applicant prefers to approach normal body constant value within the art. It is the duty of food and beverage providers to offer many balanced foods and beverages to fit customers' health need. It is not realistic for a consumer to have every making plus using tool and training to balance their eating and drinking at each occasion.

Even if some deviation was out of the range of constant physiological value, the best and the smoothest way to pull it back is by a physiological force in a physiological range. Particularly, smooth changes work better for chronic conditions. Because another deviated extremity on the opposite side is another abnormal condition, which can lead to severe frustration, bunking or even crisis that the present art intends to stay clear away. Natural food composition should work together in a harmonious, tasty, and healthy manner and conventional separation among different categories may not be the best method and product. The disclosure does not practice free from bias and it is quiet common to have bias. However, such bias should be intentionally controlled within the range of compensation capacity or at least could be neutralized as a balanced product. The present art differentiates from the tendency of concentrating on taste alone, on sugar alone, on no-fat alone, on fiber powder/pill alone, or on single reinforced heavy metal that can be very difficult for the body to eliminate and the body may not even have a chance to balance it due to ferocious intake.

Emphasizing on an isolated factor without proper assistance may cause problems because the body likes integrity. Each invention and discovery, by definition, should be new, useful, and unobvious from prior record. An invention or discovery, of course, is not necessary to be limited or shaped to the classification restriction of prior record. Independent structure, making and using operate together to set up the borders of the new art of eating and drinking superior to prior teaching. Natural nutrients should not be forced to be separated and should be allowed to act cooperatively for enhanced health fitness and taste enjoyment as the specification, examples, and claims described.

13. Microbial Stability

As controlling microbial growth is an ongoing concern among beverage manufacturers, several technologies have developed. For example, sorbic acid, benzoic acid, alkali metal salts, and phosphates act synergistically to inhibit microbiological growth in 0.1-40% fruit juice in hard water (Smith et al. U.S. Pat. No. 6,126,980). However, since most beverages are based on a sugar-acid-chemical system that is incorporated herein by references, the opposed side, e.g., the near neutral pH and low chemical system of this beverage can be difficult to fit in prior art. Thus, there are a few different respects have to be addressed as aroma-alcohol-filter system. For example, soaking chipped wood and herbs in a liquor or wine will not only enhance the flavor development but also sterilize the material. Pre-roasting wood and mild toasting herb also help both aroma development and sterilization. Adding such alcohol to a beverage will provide a quick energy release and deep flavor. Even though the liquor used for soaking contains alcohol average about 35%, the alcohol concentration of the beverage is adjusted to ≦3%, so that it will hardly to induce drinking related problems or alcohol tax. It is cost effective to transfer the food mix in a condensed form or dry form and then add water in distributor's location. In contrast to carbonation, sterile inert air, aroma, and alcohol works better as flavor and foaming head carrier as well as constant sterilizer. A solid phase does not have to be carried by a liquid; instead, a solid can be a good carrier for its liquid and air content. A non-sugar solid can isolate the oxygen better than a plastic bottle. Glass container is superior to polyethylene because glass can hold air phase with least leakage and annoying taste. Adding milk also improves the flavor, stability, and disposability. Water should contain no off-odors and be filtered by a 2-5μ filter or boiled in a range about 85-105° C. to increase the microbial stability. Filtering reserves more refresh flavor in the clear drink. Active carbon filter can remove chlorine and foreign orders. Heating removes excessive chlorine and adds a smooth caramelized or roasted malt flavor in a dark thick beverage. Pasteurized with 140° F. heat for 10 minutes will allow the beverage to survive long periods of storage without refrigeration but kills the fresh, on tap flavor. However, vigorous rolling boil could boil away the aroma, sharp flavor, essential oil, and heat unstable vitamin. For a refresh aroma, alcohol is the best native extractor, and therefore, the alcohol liquid that contains aroma and extract should be added in the very end in a cool temperature. Furthermore, when an herb remedy is used in a small amount as a flavor or when available starch or protein is below 0.1%, the beverage can be still appeal to humans but not to bacteria and yeast. Moreover, aseptic processing and packaging of pasteurized beverage are shelf stable for months due to free of spoilage microorganisms.

14. Embodiments

All following beverages contain approximately 2-30 wt % solid and add water to 100wt % (70-98 wt % total moisture or water), providing multiple pleasant sensory stimuli that mean more than just taste. The taste is selected from bitter, sweet, sour, spicy, hot, cool, aroma, e.g., hop, wood, herb, flower, vegetable, tea, vanilla, citrus peel, coffee, cocoa, essential oil, plain, mild salt; alcohol (ethyl or higher), fruit ether, no-harm organic aromatic material, protein, or a mixture thereof. Other alternatives include pungent, unadorned, fruit, broth, seafood, etc. Sweetener can be obtained from stevia, liquorice, inositol, isomalt, glycine, honey, sugar alcohol, sugar, artificial sweetener, etc. Warm beverage is preferably to be consumed in a range of 30-42° C. whereas cold beverage in a range of 5-20° C., particularly 10-20° C. Preferably 2-30 species in one beverage, particularly 3-20 species.

### EXAMPLE 1

### Aromatic Beverage Cocktail

| Edible content | Weight percent (%) |
|---|---|
| rose* | aroma |
| grape | flavor |
| fructose/sugar | 5 |
| ball** | 9 |
| aromatic gas | suitable |
| milk*** | 7 |
| stabilizer | suitable |

*Alterative: bamboo leaf, tangerine/orange skin, corn skin/stigma, plum blossom, osmanthus, clover, jasmine, Melissa, savory
**An edible ball made of tea, egg, vegetable, sea plant, bean, grain, butter, fat, starch, gelatin, coffee, or seaweed, which is water insoluble and shaped to pass a straw. Tea is used for teeth protection
***Cow milk, soy milk, bean milk, grain milk, house milk, or goat milk

### EXAMPLE 2

### Aerated Vegetabel Beverage

| Edible content | Weight percent (%) |
|---|---|
| pepper* | 7 |
| pear | 3 |
| sucrose | 5 |
| sorbitol | suitable |
| farmer air | 2 volumes |

*Alterative: celery, corn, turnip, corn skin, carrot, asparagus, cabbage, green, parsley, coriander, radish, collard, kale. Carotenoids content: ⅔ cup cooked kale: 22,610 ug, 1 cup tomato: 23,546 ug, 8 strawberry 62 ug (J Am Dietetic Association 93: 284, 1993).
Pepper is fresh and cut to small pieces.

### EXAMPLE 3

### Carbonated Seed Beverage

| Edible content | Weight percent (%) |
|---|---|
| basil seed | 7 |
| milk | 5 |
| fructose | 5 |
| aspartame | suitable |
| CO2 | suitable |

Basil seeds have anti-gout effect. The seeds float evenly in a liquid and can smoothly pass a straw. Also, mung bean skin, which is a side product in sprouting process, can be used. Alternative fruit needs to be crisp or at least can stand cold without changing color, e.g., Korea melon, plum, cantaloupe, melon.

### EXAMPLE 4

### Guava Milk Beverage

| Edible content | Weight percent (%) |
|---|---|
| guava | 1 |
| grape | 2 |
| soy milk* | 7 |
| orange skin | flavor |
| honey | 5 |
| aromatic gas | suitable |
| stabilizer | suitable |

*Alternative: milk, mung bean milk, coffee, chocolate drink
The pH is adjusted to ≧5.0 because many amino acids deposit if it is out of isoionic point.

### EXAMPLE 5

### Beer Flavored Barley Beverage

| Edible content | Weight percent (%) |
|---|---|
| Partial fermented barley* | 10 |
| hop | 2 |
| orange peel | 0.5 |
| milk | 3 |
| CO₂ or aromatic gas | suitable |
| sugar | suitable |

*Used beer yeast contains highest amount of VB and many essential amino acids. Initial fermentation is enough, not waiting to the end.

Alternative: partially fermented grain, bean, preferably whole rice, buckwheat, barley, or millet. Millet has the sweetest taste and richest body.

### EXAMPLE 6

### Wine Flavored Beverage

| Edible content | Weight percent (%) |
|---|---|
| Partially fermented glutinous rice | 12 |
| red wine | 3 |
| sweet-scented osmanthus | flavor |
| malic acid | flavor |
| sorbitol | flavor |
| sweeteners | suitable |
| CO2/aromatic air | suitable |

### EXAMPLE 7

### Balanced Dietary Beverage Bag

The package contains, by weight, cooked and dehydrated red bean 4-7 parts as solid; fermented and dehydrated rice or grain 3-5 parts as solid, mild roasted milk powder 2-4 parts as liquid thicker, flower, vegetable, herb, or fruit 0.2-1 parts as liquid flavor. Small amount of carbonation agents will active a motion drink, plus an air phase and a fresh flavor. Sweetness is selected from stevia, liquorice, fructose (levulose), glycine, maltose, sucrose, aspartame, or acesulfame K. Add hot water, tea, beer, wine, soft drink, or milk to full amount.

### EXAMPLE 8

### Mild Salty Milk Tea Beverage

| Edible content | Weight percent (%) |
|---|---|
| Tea | 0.1-1.0 |
| butter | 1 |
| salt | 0.1-0.9 |
| roasted millet or tofu as solid | 10 |
| dehydrated vegetable or pea | 0-2 |
| milk | add to full |
| aromatic gas | suitable |

After being boiled, the tea is filtered and thrown away. Adding a small amount of butter and salt, and stir well before adding milk. The pH is adjusted to isometric point of milk protein.

### EXAMPLE 9

### Cocoa Beverage with Grain Solid

| Edible content | Weight percent (%) |
|---|---|
| Fermented whole rice or barley* | 7 |
| cocoa | flavor |
| aroma gas | suitable |
| stabilizer | suitable |

*Alternative: Soak bean in vinegar or wine and then roast the whole bean in a temperature from 98-125° C. for about 5-40 minutes or right before turning to cinnamon color.

### EXAMPLE 10

### Soup Beverage for Reducing Appetite

| Edible content | Weight percent (%) |
|---|---|
| Polygonatum*/ophipogon/dendrobium | 0.03-1 |
| glutinous rice | 3 |
| barley** | 4 |
| aerated meat balls | 4 |
| Glutinous rice, edible herb, and honey work together to reduce thirst and eating urges and benefit the metabolism. Barley has mild diuresis that helps reduce edema-like overweight. | |
| *Polygonatum sibiricum, polygonatum odoratum. Alternative: rehmannia glutinosa | |
| **Alternative: White bean and milk provide lowest glycemia index. Plant fibers delay food digestion and absorption, reduce insulin resistance, and result in less postprandial hyperglycemia. Protein helps the maintenance of HDL (High Density Lipoprotein) when the cholesterol is lowered. These edible herb will taste better when boiled with red bean soup, broth, barley, or glutinous rice. Their appetite reduction does not like phen phen, | |
| #they start slowly, making people feel full and eat less, which last for more than days. | |

### EXAMPLE 11

### Fermented Whey Beverage

| Edible content | Weight percent (%) |
|---|---|
| Fermented milk or whey* | add to full |
| minces of sea plant | 7 |
| almond aroma | flavor |
| stabilizer | suitable |

*Horse milk makes sweeter fermented drink than cow milk. The alcohol is low and the feel is rich, round, deep and soft.

### EXAMPLE 12

### Diet Vegetable Beverage

| Edible content | Weight percent (%) |
|---|---|
| Tofu* | 3 |
| crab | 3 |
| winter melon (wax gourd)** | 5 |
| CO₂ | suitable |
| stabilizer | suitable |
| *Tofu can be frozen in advance to create many small crystal chambers, which will help the tofu float. Alternative: taro or yam. Chinese yam contains a mucoprotein, which reduces fat deposit on cardiovascular system, helps maintenance of the vessel elasticity and reduces blood glucose levels. Chinese yam is heated above 95° C. and is cut to small pieces to be sucked through a straw. Taro and yam are close alternatives. | |
| **Winter melon contains propanol diacid, which reduces fat deposit to adipose tissue and reduces blood glucose levels. Its high V_{B1,2}, contents help normalizing carbohydrate metabolism. Cucumber also contains propanol diacid, which blocks the transition of sugar to fat without disturbing normal carbohydrate metabolism and helps impotence caused by obesity. Many home made soups can be easily incorporated into appealing beverages, e.g., bamboo, mushroom, spinach, seafood, sprout, | |
| #turnip, celery, kelp, cabbage, carrot. Beside vegetable solid, ball solid can also be used. | |

### EXAMPLE 13

### Beverage for Hypertension/Arteriosclerosis

| Edible content | Weight percent (%) |
|---|---|
| Kelp | 1 |
| Job's tear | 1 |
| fish | 2 |
| mung bean | 4 |
| celery | 3 |
| corn | 1 |
| honey | 1 |
| magnesium | 0.015 |
| stevia | suitable |
| aromatic gas | suitable |

Dehydration stress is not uncommon in the population of hypertension group. Many people use diuresis or restrict liquid and salt intake for reducing blood pressure, which should be taken up to the point before dehydration. Since dehydration stress accelerates aging problems and may increase angiotension release, a tasty balanced drink can be a feasible solution to the problems. Magnesium supplement helps a large number of health conditions, e.g., hypertension, cardiovascular disease, diabetes, hearing loss, migraine, angina, asthma, and constipation (Gullestad et al, Oral vs. intravenous magnesium supplementation in patients with magnesium deficiency, Magnes Trace Elem 10:11-16, 1991). Magnesium blocks the entry of calcium into vascular smooth muscle cells and heart muscle cells, and therefore, vascular resistance and arteriosclerosis are reduced and blood pressure is lowered. The average intake of magnesium by healthy adults in the U.S. rates has reduced to 143-266 mg/day, which is obviously below the levels of RDA recommended 280 mg for women and 350 mg for men. Since most refined flours will lose magnesium, vitamins, and nutrients, grain in intact botanic feature will not only provide a tasty solid in a beverage but also solve the problem of nutrient lose during refine milling. Kelp contains magnesium as high as 7.6 mg/1 g (M Murray, Encyclopedia of nutritional supplements, Prima Health, 1996), and is tasty native float in ocean. Hard water carries more magnesium than soft water and therefore should not be excluded. For dental and bone health, fluoride is set forth in proportion in the beverage just as regular water.

Consumers with hypertension often need sodium-restricted diet and therefore soda (sodium) should not be added. Soy is well known for its estrogen-like benefit in cardiovascular system. Mung bean reduces blood pressure, blood sugar and eating urgency. Banana contains serotonin, which is believed as a chemical signal to the brain, which helps people relax. Current research also discovered that banana contains angiotension inhibitor substance, which prevent hypertension and works well with its high potassium content. Celery has been a popular food for reducing hypertension. Lotus seed helps in reducing insomnia and heart problem. N Eng J Med 1997 reported a clinical trial that a diet rich in fruit, vegetable and low fat dairy foods with total reduced fat can substantially lower blood pressure by 5.5/3.0 mmHg in volunteers.

### EXAMPLE 14

### Beverage for Cough/Smoking

| Edible content | Weight percent (%) |
|---|---|
| Houtuynia | 0.5-1 |
| pear | 3 |
| turnip | 3 |
| walnut/almond | 3 |
| black bean | 3 |
| honey | 3 |
| ascorbic acid* | 0.01 |
| green tea** | 0.1 |
| stabilizer | suitable |

*Hoping these biological active agents can combine with nicotine to form a vitamin-nicotine like compound and to reduce the nicotine carcinogen effect. Turnip, pear, walnut, almond, white bean, black bean, and honey work together to soothe the cough and improve the general health. Current research found that carrot intake reduces the risk of lung cancer by 65% with broccoli as a close second.
**Alternative: Aerated echinacea/pau d'arco tea. Mushroom has a light smoke order and its anti-carcinogen effect helps reduce the cigarette damage. Recommended Vc for normal customers is about 60 mg per day. A cigarette smoker needs at least as twice much as needed by non-smokers.

### EXAMPLE 15

### Beverage* for Reducing Winter Cold

| Edible content | Weight percent (%) |
|---|---|
| White turnip | 10 |
| green onion | 1 |
| chicken | 3 |
| astragalus root | 0.4 |
| ledebouriella root* | 0.2 |
| aromatic gas | suitable |
| liquorice | suitable |
| *Alternative: echinacea, pau d'arco, lobeliaor slipperyelm, isatis root/leaf. Astragalus and ledebouriella in a ratio of 2 to 1 are excellent combination for reducing hyperhidrosis. Chicken soup increases the body's immunity. Ginger and green onions help the body to sweet and sooth sinus catarrh. Sweetness and mild salty add delicious to the soup beverage. However, heavy salt and sugar use decrease the mucous resistance in | |
| #respiratory tract and make the person easier to catch a cold. Chamomile possesses a delicate flavor and reduces headache, joint pain and asthma. Cayenne may soothes arthritis and add additional flavors. Parsnip can provide a taste of ancient drink through current manufacturing. | |

### EXAMPLE 16

### Summer Beverage

| Edible content | Weight percent (%) |
|---|---|
| Peppermint | 0.01-1 |
| glutinous rice | 5-15 |
| hop/seafood mixed ball | 5 |
| CO₂ or gas | suitable |

Alternative: hop, yeast, kapok, prunella, daisy, honey suckle, chrysanthemum.

### EXAMPLE 17

### Navy Bean Beverage with Air Phase

| Edible content | Weight percent (%) |
|---|---|
| Navy bean | 6 |
| shrimp or blue crab | 5 |
| wine | 2 |
| aromatic gas* | 0.5-2% by volume |

*Alternative: ocean smell air

### EXAMPLE 18

### Beer & Pear Beverage

| Edible content | Weight percent (%) |
|---|---|
| Buckwheat or barley | 7 |
| pear | 3 |
| hop | 1 |
| aromatic gas | suitable |

### EXAMPLE 19

### Low Calorie Anti-Carie Beverage

| Edible content | Weight percent (%) |
|---|---|
| Lotus leaf or bamboo | 0.05-1 |
| leaf tea | |
| aerated cheese balls | 5-15 |
| stevia | suitable |
| fluoridized water | add to full |

*Lotus leaf and bamboo leaf have a sharp aroma and cool nature, and are native preservatives.
**Dislike sugar, fat does not cause caries. Instead, chess helps reducing caries. The ball is made of whole jasmines surrounded by aroma aerated cheese so that it will not deteriorated because of been soaked in water.

### EXAMPLE 20

### Ocean Boat Beverage

a) Seasoning and toasting a seaweed or vegetable and cuting it into small pieces

b) Mixing a) with an egg or cheese liquid which is aerated by an aroma air,

c) Molding b) into a boat shape,

d) Adding c) into a liquid to allow c) floating on such liquid.

15. Avoid Negtive Interaction Among Foods, Nutrients & Herbs

Beside the unsolved problems existing in common in prior art as discussed above, more solutions need to be addressed to avoid unwanted interaction among food ingredients. For example, cucumber and carrot contain an enzyme that breaks VC and therefore, should not be combined with high Vc component. FD & C yellow #5 antagonists VB6 that assists protein metabolism (Murray Encyclopedia of Nutritional Supplements, p110, 1996). Acidic food is not used for obesity because increased rate of disruption of food in the presence of acid. In Houghton et al's experiment, no pancake meals were broken up within 150 minutes by mechanical agitation in a normal saline medium, but both were disrupted in the presence of acid-pepsin, the light consistency pancake being broken up more rapidly than the heavy consistency pancake (0.5 v 0.2 radioactivity appearance) (Houghton et al., Gut 1987, 28, 1584-88). Therefore, the disclosure focuses on multi-phase food and beverage to against quick digestion, which is a common problem seen in homogeneous food and beverage.

16. Combining Multi-Phases & Flavors in one Product

The invention prefers not using emulsifier so that the air phase will be free to go when the pressure is reduced. Alcohol reduces the surface tension of a liquid and helps air out of a liquid. Solid phase can delay the eating period in the mouth due to chewing activities and smooth touching pleasure. The invention can be applied to aroma aerated beverage, carbonated herb beverage, vegetable ball floating in a drink, chocolate having aromatic coffee fluid chambers, and cheese ball having juicy inclusions. Differentiated from aromatherapy, which involves heating a few drops of the essential oil of the aromatherapy in a ceramic vaporizer (Lees, the book of practical aromatherapy, 1992, Keates), the aroma of the product is in its active air phase ready to fly to consumers' olfactory nerve.

The flavors of fruit juice, wine, beer, herb tea, and aroma therapy have been known for a long time. However, it is not known to hybridize diverse featrues among foods and food technologies to obtain the following unexpected result:

CO₂ carrying a smell+solid having a water stable coating of protein, fat, and fiber+isotonic liquid with a motion+delicious taste with nutritional balance≈present beverage

The feature of the disclosure is a combination as: aroma+alcohol+amino acid+plant fibers+nutrients+soft drink convenience+stereo motion from the best aspects of each individual common components.

17. Cooperation Among Foods, Nutrients, and Herbs

To resolute the conflict between nutrition and taste, the application has found it is possible to combine multiple phases and categories of foods to improve both taste and nutrition. The disclosure provides a novel method preparing a multi-categories of food ingredients for quick, medium, slow energy releasing and a stereo product made from such method. The specific mechanism for why the combination yielding synergistic result is further upon the following clarification:

Multiple flavors maximize the contrast of flavors and enrich the enjoyment. Solid is the best form to hold multiple flavors inside the solid or among different phases. Sweet and bitter are the best match, e.g., a sweet fermented liquid with a bitter flavored coffee or tea balls, a sweet ball with a bitter drink, which will not only compensate the tastes of each other, but also provide a favorable nutritional coaction among ingredients. The bitter taste can quench thirst and eating urgency. Tea provides excellent antioxidant as anticancer drink plus and reduces caries. Cranberry inhibits G⁻ bacteria to attach the mucous of urinary tract or teeth. The sweet taste can calm an infant when the infant is crying as well as calm adults. Fermenting a liquid increases its flavor and aroma. Solids last longer whereas gases act faster. In contrast to prior beverages, sour and sweet in this beverage are less preferred because sour will smother the sweet and easily increase the desired amount of sweetness to double, which can induce glucose overload on glucose intolerance consumers with increased caries and blood triglyceride levels in hyperlipedemia consumers. Plain base can carry more delicate flavors for deep searching. Pungent and cream are another match to cover deep taste. The aim of the beverage is to combine a modest amount of each ingredient to approach a favorable coaction and to avoid adverse effect trigged by an extreme or high dose, which breaks the balance. Multi-phases allow consumers to turn drink into a stereo dimension of taste, smell, and mind.

The method of making, combing, and using the beverage for quick, medium and slow ingredient releasing, comprising at least three steps of

a) providing a direct energy supply, which can be utilized by human without insulin, comprising approximately 3-5 wt % honey, glycine, isomalt, inositol, alcohol sugar, or fructose, capable of reducing sugar craving; or 0.3-2.5 wt % alcohol capable of providing a swift energy and tonic,

b) providing a quick energy supply, which can release insulin secretion suppression, comprising up to 5 wt % sweeteners. Such sweetener is selected from sucrose, glycine, maltose, isomalt, levulose, inositol, acesulfame K, aspartame, glyceride, tryptophan, liquorice, sugar alcohol or ester, saccharin, alitame, sucralase, D-tagatose, or a mixture; or up to 20wt % total simple carbohydrate, alcohol, starch, flour,

c) providing a slow energy supply or incorporating at least 5 wt % plant mix or complex carbohydrate into the beverage, or at least 20% by calorie plant mix. Such plant mix is selected from bean, vegetable leaf, root or seed, sprout, fruit, oat, buckwheat, barley, yeast, seaweed, sea plant, spirulina, wheatgrass, sea-living organism, or a mixture. For example, sprout, fruit, oat, buckwheat, barley, yeast, kelp, seaweed, sea vegetable, spirulina, wheatgrass, or sea-living organism.

d) providing 10-37 g natural fiber per 2000 calories capable of prolonging digestive time and improving blood sugar and lipid levels. Such fiber is selected from bean, grain, vegetable leaf, seed, or root, edible herb, fruit, tea, coffee, chocolate, yeast, spirulina, chlorophyll, wheatgrass, germ, water-living organism, or a mixture,

e) adding up to 25 wt % solid. Such solid has a smooth surface, a chewable texture, or a capacity of passing a straw smoothly,

f) adding at least 0.5% by volume gas, which increases the contact surface between the beverage and the mucous, enhances the penetration of the beverage flavor, releases a smell that makes human feel comfortable and fresh, or at least does no harm,

g) providing up to 30% by calorie protein capable of producing gluconeogenesis, enhances fat burring and stabilizes the blood glucose levels not fall back,

i) providing up to 30% by calorie fat, capable of producing cholecystokinin, enhancing satiety, providing essential fatty acid, and slowing down food absorption,

j) adjusting pH into a range approximately 3.5-7.8, prefer 4.0-7.2

whereby such components work together for flattening postgrandial glycemia response over an extended period of time with improved metabolism and enriched sensory satisfaction within less calorie allowance through the coaction of multiple phased ingredients thereof.

Also, the method of making, combining and using a nutritional food as food therapy having favorable cooperative effect on human health, comprising at least 2 steps of:

a) providing at least 2 species of natural food categories or components into single fast food product having at least one cooperative function among said food ingredients.

b) providing at least one therapeutic effect amount of edible ingredient for eating responsive condition, wherein said condition comprising eating urgent, diabetes, energy metabolism, overweight, hyperlipemia, heartburn, or gastric reflux, kidney stone, arthritis, osteoporosis, diverticulosis, hemorrhoid, constipation, breast cancer, or colon cancer.

c) providing at least no contraindicated effect known among components of said fast food, or between said components and expected health effect. Any component having conflict of toxin or contraindication with another component or expected nutritional function should be avoided.

d) providing no trans fatty acid, artificial color, or artificial synthesized fiber network to be digested.

e) labeling said beverage in total calorie amount with proportional nutrients referred to ideal body weight, age, activity, height, time, or drinking responsive conditions.

f) providing 10-37 gram fiber per 1500-3000 calories product.

Richest natural fiber sources include vegetable and bean. 100 calories of food contain fiber by weight as follows: raw cucumber: 4.61 g, boiled broccoli: 3.96 g, boiled cabbage: 2.86 g, raw carrot or pear: 2.4 g; cooked red bean: 2.2 g, white bean: 1.8 g, boiled pea: 1.67, peach: 1.5 g, apple: 1.3 g, orange: 0.9; soybean: 1.17 g, macaroni: 0.80 g, mung bean: 0.43 g; wheat bran: 45.39 g, wheat germ: 0.60 g, oat: 0.32 g, millet: 0.30 g, brown rice: 0.31 g, barley: 0.19 g, white rice: 0.072 g; meat: 0, sugar: 0, fat: 0, and animal originated food: 0. Average vegetables and beans contain fiber about 2 g/100 calories (40 g/2000 calories). Fruits contain average fiber about 1.5 g/100 calories (30 g/2000 calories). Refined grains contain about 0.5 g/100 calories (10 g/2000 calories). Conventional beverages contain almost no fiber. Most vegetable and bean, by nature, are in alkali side. Meats and sugars are in acid side. Although water should be neutral, many laboratory measurements show water pH as 6.0-6.5. H+ could be added to fiber to enhance fiber-binding power of saturated fat. Differentiated from typical fiber supplements that have to be taken with water, the disclosure combines the convenience of beverage with proportional natural fiber and nutrients. The fiber in the invention includes all kind fibers, water insoluble: lignin (woody fiber) and cellulose; water soluble: hemicellulose (pectin,), mucilage, and guar gum.

The product may comprise nutritional supplement or edible herb remedy up to 5% by weight, preferably 0.002-3wt % for cooperate with main food to normalize eating and drinking related conditions and improve health fitness. The method further includes a special beverage for a special season, or drinking responsive condition.

1) Food, Nutrient, & Herb Combination for Hypertension & Diabetes

In view of the restriction of sodium and water in common practice of hypertension diet, it worth notice that dehydration may stimulate angiotension axis. Consequently, the body will try to reserve remain water and may raise blood pressure. Dehydration is related to stress, angina and cataract. Still more, the lack of sodium relates to myocardium infarction. Thus, keep the beverage composition in balance is the best solution for problems. Also, current survey in medical students of Okalahoma City indicates that caffeine synergistically coacts with stress to increase blood pressure. The adverse effect is even more obvious if there is positive family history. Dr. George found that 1 cup of coffee can raise blood pressure average 5-15 mmHg and last 12 hours.

In contrast to emphasize on calcium supplementation, magnesium and potassium are far more important for hypertension and diabetes group. Potassium levels play critical factor for hypertension control. Low levels of magnesium raise susceptibility to hypertension, angina, heart failure, recurrent kidney stones, cancer, insomnia, postmenopause syndrome, muscle cramps and menstrual pains. Comparing to “Calcium channel-blocker drug”, magnesium is a native calcium channel blocker to reduce hypertension with much less side effects. Furthermore, magnesium participates in more than 300 enzymatic reactions, particular energy metabolism, which directly relates to diabetes.

To solve this drink related problem, the disclosure offers warm soup beverage and aromatic hot drink as a functional food with edible herb as assistant. The beverage is first designed on synergic action with corresponding flavor adjustment as second. For example, folic acid is used for reduce osteoporosis and homocysterine, which is an independent help factor for cardiovascular disease. In addition, folic acid reduces depression and therefore offering multiple protective effects for consumers within this group. Gamma-linolenic acid, evening primrose oil and fish oil with calcium supply results in higher bone density and fewer fractures than the placebo group (Kruger et al, Calcium, gamma-linolenic acid and eicosapentaenoic acid supplementation in osteoporoses, Osteopor, Int, 6(suppl. 1): 250, 1995). Although cinnamon, pepper, aniseed, spice, caffeine, and sugar can make a very tasty beverage, current research has indicated that cinnamon, pepper and aniseed may induce cell mutation and change DNA. Since high manufacturing technology has been widely used in vast processes and consumers desire to see specialized beverage to fit their needs in different age and sex group, the applicant is intending to make a tasty beverage with the least adverse effect of material possible.

V_{B2}, V_{B6}, V_{B3}, V_{B12}, V_{E}, inositol, folic acid, lysine, methionine, carnitine, Coenzyme Q₁₀, buckwheat, oat, garlic, eucommia leaf, evening promrise, celery, corn stigma, eggplant, tomato, soybean, egg white, kelp, water chestnut, waxgourd, cucumber, sea cucumber, bitter melon, flaxseed, lotus leaf, bamboo leaf, buck wheat, dogwood fruit, wolfberry fruit, calm, fish, melon, lycium, job's tears, gymnema sylvestre, persimmon leaf, rhizome of wind-weed, scrophularia ningpoensis, white peony root, eucommia ulmoides, poly gonatum, ophiopogon japonicus, rhizoma polygonati, cruel rehmannia root, Chinese yam, pear, snow water, H+ ionized water, glutinous rice, reduced wheat, chrysanthemum, prunellae spica, mori folium, lucid asparagus, orange peel, peppermint, catnip, nettle, rose hip, alfalfa, sage, raspberry leaf, fiber magnesium, potassium, selenium, zinc, chromium, choline or lecithin, with calcium 500-800 mg, magnesium 400-700 mg, sodium 0.5-2 g, potassium, 2-5.5 g, sweet sugar <7% by weight; pH >4.5, prefer >5.0, saturated fat <7% by calorie, cholesterol <200 mg, or fiber 20-37 g per 2000 calories for improving metabolism and controlling eating urgency, overweight, diabetes, hypertension, arteriosclerosis, strike, hyperlipedemia, or syndrome X. Preferably no gluten for susceptive child in high diabetes II tendency family; particularly no ginseng, soda, aspartame, or monkshood extract for hypertension. Orange peel is not used because they may increase blood pressure. Sage helps relax peripheral blood vessel and reduce blood glucose levels. Rhubarb is used in a small amount as a purgative to clean the colon.

2) Food, Nutrient, & Herb Combination for Reducing Cardiovascular Problem

Beside exciting brain activities and eliminating vitamins, Ca, and Mg from urine, caffeine increase hypertension and glycogen release, which increases blood sugar. For combating fatigue, many herbs can make novel beverage without adverse effects of caffeine. For example, nettle fights tiredness and arthritis, increases energy, and reduces hyperlipemia. Furthermore, nettle helps prevent premature hair loss, reduces kidney stone and prostate hyperplasia. Orange and tangerine peels combat fatigue and provide a delicate aroma of essential oil. Parsley reduces blood clot. Peppermint has a cool fresh nature and helps reduce aches. Chrysanthemum beverage has a mild sweet and bitter with fresh aroma, which helps calm anxiety and reduce hypertension symptoms. Catnip calms nerve and helps sleep. Pessimism leaf can make a tasty tea and help reduce blood pressure. Fresh rose hip contains very high Vc and its diuretic effect helps controlling blood pressure. Alfalfa contains rich minerals and strong grass smell, making people feel fresh and comfortable. Cassia seeds help reduce blood pressure/hyperlipemia and improve the acuity of vision. The mild laxative effect of cassia seeds relieves constipation. Raspberry leaves possess delicious flavor and dilates smooth muscle. Plus, their vitamin B & C components improve glucose tolerance and the liver function. VE can reduce cellular damage caused by diabetes. Most eating urgencies have two components. One is gastric empty and growling for filling, which is solved through increasing the gastric empty period by optimal food structure, e.g., combined liquid with solid, including both water soluble and insoluble fibers. Edible herb is added to enhance the appetite control. Particularly, polygonatum, ophiopogon japonicus, and lucid asparagus can also prolong the gastric empty time and significant help control gastric eating urgency. Another eating urgency appears as oral impulsive compulsion. Some consumers feel nervous and would like to put things into their mouths even when the stomach is bloating and painful, which is addressed by increased sensory touches and aroma induced relax with appealing tasty fiber made solid for chewing pleasure and flavor. However, high rosemary can increase blood pressure and therefore is not used in the beverage for hypertension.

Furthermore, spirulina helps stable blood glucose and weight control. Tupelo contains highest levulose and slow absorb rate (Balches, Prescription for Nutritional Healing 1999). Chromium 100 mg and lipoic acid 800 mg can be very helpful for diabetes. Fish and flaxseed contain high omega-3 fat acids and can be favorable add in the solid. Particularly, provide an effective amount of magnesium, potassium, coenzyme Q-10, inositol, methionine, glutamine, phytoestrogen, or ginkgo biloba, for reducing the risk of cardiovascular disease and myocardial infarction.

3) Food, Nutrient & Herb Combination for Reducing Kidney Stone

Also the beverage may comprise an effective amount of VB6, VA, lysine, lysimachiae, glutamic acid, cranberry, barley, black bean, water melon, rose hip, citrate acid, EDTA, magnesium 250-700 mg, calcium 500-800 mg, potassium 2.5-5 g, sodium 0.5-2.0 g, molybdenum 75-250 μg per 2000 calories with pH≈3.0-7.2 for controlling kidney stone. Majority of urine stones form from calcium deposits. Magnesium can compete with calcium and reduce stone formation. High sodium food should be avoided because salt can form a core for a stone to grow bigger. Abumrad et al., 1981 found that molybdenum 163 μg per day improves sulfur and uric acid metabolism in long-term total parenteral nutrition. When urine pH is less than 6.5, the chance to form a calcium stone is less likely. Drinking less than 1 liter will condense salt concentration in urine, which may cause stone to form. Drinking 2 liters water or beverage per day is needed and 3 liters per day is even safer. Also, high oxalate food, e.g., spinach, bamboo, asparagus, and high purine/saturated fat food e.g., chicory, cheese, should be limited to a small amount in the beverage.

4) Food, Nutrient, & Herb Combination for Bowel Health

Another embodiment of the beverage comprising an effective amount of pear, V_{A}, V_{B2}, magnesium, psyllium, dehydrated used beer yeast, goldenseal, yarrow, lemon thyme, blessed thistle, sophora flower, cogongrass rhizomes with no spicy, toast, caramel, aluminum antacid, aluminum additive, apricot, or apple for reducing hemorrhoid, diverticulosis, constipation, or colon cancer. Goldenseal and yarrow help bowel emptying, protect gastrointestine mucous and make ideal beverage for reducing constipation and colon inflation. Lemon thyme also protects mucous and increase bowel movement. Plus, lemon thyme can release a noble smell and relief pain. Blessed thistle (milk thistle) also reduces constipation. Dehydrated (used) beer yeast contains very high V_{B}. Heat process for this beverage is adjusted in a range of 60-120° C. Heavy roast, caramel, and apple help reduce diarrhea, but may shift constipation status to an unwanted direction. Furthermore, majority fiber supplements need a large amount of water to enhance its volume effect on the bowel before a meal. Actually, nothing can work better than a tasty beverage, which contains fiber, beneficial herb and balanced nutrients as a combined food therapy on bowel health.

5) Food, Nutrient, & Herb Combination for Reducing Over Sweating & Cold Intolerance

Further embodiment of the beverage comprising an effective amount of Vc, V_{A}, zinc, lemon thyme, garlic, parsley, ledebouriella root, astragalus root, polygonatum, radix ophiopogonis, alfalfa, evening promise, catnip, light wheat, liquorice, lotus leaf, or comfrey leaf or root for reducing over sweating or cold intolerance. Lotus leaf helps sooth summer heat and weight control.

6) Food, Nutrient, & Herb Combination for Reducing Vomiting

The food and edible herb remedy for reducing vomiting and stomach upset is selected from tangerine leaf or peel, ginger root, tea, inula flower, clover, milk, starch, toast, grape vine, liquorice, kaki calyx, perilla leaf, reed rhizome, lemon, lemon thyme, rosemary, thyme, rosehip, peppermint, comfrey leaf or root, alfalfa, raspberry leaf, V_{B6}, or eagle wood with related pH in a range from 4.0 to 7.5.

7) Food, Nutrients, & Herb Combination for Eye

The nutritional supplement and herb remedy for helping vision and reducing eye problem is selected from V_{A}, V_{B1}, V_{B2}, V_{C}, V_{E}, coenzyme-O10, omega-3 fatty acid, zinc, selenium, inositol, bilberry, mulberry, or berry, polygonati rhizoma, N-acetyl cysteine (glutathione precursor), taurine, bioflavonoid, sicklesenna seed, boxthorn, chrysanthemum, milk vetch seed, lycium barbarum, cassia seed, prunella vulgaris, mulberry leaf, rhizoma, polygonatum or rehmannia root or a mixture. Liquor, aspartame, hot pepper, and garlic are not used for improving vision.

8) Food, Nutrient, & Herb Combination for Prostate Health

Another example comprises adding an effective amount of V_{E}, Vc, zinc, alanine, glutamic acid, glycine, evening primrose, linseed oil, soybean, glutinous rice, waxgourd, towel gourd, eucommia bark, green chives, white part of green onion, red phaseolus bean, bamboo leaf, mung bean, job's-tears seed, nettle, grass pollen, saw palmetto, pygeum africanum, tomato or lycopen, damiana, rhizoma polygonati, or rehmannia root for reducing prostatic hyperplasia. This condition affects almost half of susceptive male population in industrialized countries. Glutamic acid, glycine and alanine capsule in 2 capsules of 1 g each three times daily have made 14 out 17 cases get symptom reduced without side effects (Aito, Conservative treatment of prostatic hyperplasia or BPH, Hinyokika Kiyo, 18 (1): 41-44, 1972). Zinc will not only improve cold intolerance but also will reduce the symptoms and size of an enlarged gland.

9) Food, Nutrient, & Herb Combination for Reducing Osteoporosis & Postmenopause Syndrome

The beverage also may comprise an effective amount of V_{E}, folic acid, isoflavone, soybean, gamma-linolenic acid, red date, glutinous rice, red bean, light wheat, glutinous rice, liquorice, lily bulb, white peony root, rehmannia root, rhizoma polygonati, fleece-flower root, polygonum multiflorum, oat straw, black cohosh, damiana, chaste berry, or scrophularia ningpoensis for reducing hot flash, osteoporosis, or postmenopause syndrome. Preferably, cinnamon, hot pepper, spicy, clove, aniseed, ginseng, and gingko biloba are not used. Furthermore, salt increase calcium excretion and thyroid secretion, which actives cat osteoclast activity to dissolve calcium in bone. Plus, salt could active amylase, accelerate starch digestion and inhibit respiratory tract immunity. Thus, heavy salt is avoided. However, since salt deficiency relates to myocardium infarction, the best solution is to stay in the optimal range as above. Moreover, calcium and magnesium should come in pairs because calcium supplement without magnesium increases constipation and arteriosclerosis.

10) Food, Nutrient, & Herb Combination for Stomach Health

The nutritional supplement and herb remedy for helping wound and ulcer healing is selected from Vc, V_{U}, zinc, folic acid, fish, comfrey leaf or root, alfalfa, blessed thistle, lotus root, echinacea, or rehmannia root. In addition, echinacea can help clean blood toxins, and fight infections.

11) Food, Nutrient, & Herb Combination for Reducing Smoke

The nutritional supplement and edible herb remedy for help quieting smoke and reducing free-radial related damage is selected from outtuynia, peppermint, thyme, lemon thyme, phenylalanine, St. John's wort, inositol, V_{B6}, V_{B12}, VC, folic acid, carotene, tyrosine, glutathione, inositol, leucine, isoleucine, arginine, cilantro, or liquorice.

12) Food, Nutrient, & Herb Combination for Appetite & Weight Control

The nutritional supplement and edible herb remedy for decreasing the risk of stroke, osteoporosis or stone formation during sleep is selected from tryptophan, glutamine, phenylalanine, glycine, V_{B6}, V_{B12}, coenzyme Q₁₀, Vc, magnesium, red date, raisin, parsley, oat straw, chamomile, catnip, wild jujuba seed, ginger root, or a mixture thereof, whereby eating urgency is reduced and fat burning is enhanced with decreased risk of stroke, osteoporosis or stone formation during sleep. Preferably, not use caffeine, alcohol, or diuretic for appetite or weight control.

Tryptophan can significantly reduce appetite, help sleep, and moderate carbohydrate craving caused by abnormal serotonin release (Wurtman, Behavioral effects of nutrients, The Lancet, p1145, May 1983). V_{B6} is essential in substance metabolism and hormone balance, which helps control brain appetite. When the body metabolism and hormone axis are normalized, fewer illness will occur. Phenylalanine reduces depression while depression can cause overeat. In addition, phenylalanine induces release of cholycystokin within 30 minutes, which tell the brain stop eating. However, if phenylalanine is taken with high sugar content, the sugar load and blood glucose frustration can upset the benefit of phenylalanine on weight control. The best time to have the beverage is half hour before dinner so that the appetite has been under control and therefore less calories and more complex carbohydrate will be picked up. Glutamine can reduce sugar and alcohol craving (Chaitow L., The healing power of amino acids, p 99-101, Thorsons Publishers Ltd, 1989). In addition, Vc, evening primrose oil and coenzyme Q10 also assist in overweight recovery. When both appetite and food structure/volume are under optimized condition, less correction will be needed later on. Of course, dinner is important, however, average people can only utilize ≦500 calories in whole night. So the point is the quality but not the quantity. Plus, overload cause stomach bloating, abdomen pain and urination, which disturb night sleep. Furthermore, high blood insulin will block gluconeogenesis and force extra carbohydrate and fat turn into adipose deposit. The goal of applicant is using amino acid to help appetite control and fat burning in such a cooperative way that weight loss can happen during sleep. Aromatic and warm beverages are the best option to unwind the tired body preparing for a good rest. Rose and sweet-scented osmanthus possess noble sweet aroma and lighten up the body. A deep sleep especially the first 90 minutes is most important for the body to recover as well as loss weight. Beside fluid dilution effect that reduces the risk of stroke and stone to form, the volume should carry moderate amount of calcium safely for bone deposit or bone density maintenance. Depending solely on restriction of calcium intake to prevent kidney stone may reduce the stone, but its consequentive loss of bone density is not replaceable. This is the reason the present invention adjusts calcium intake to 500-800 mg/day rather than completely removes calcium from the diet. Diuretics, alcohol, and caffeine are rather marked for morning and daytime than night. Differentiated from conventional beverage, the present beverage combines aromatherapy, amino acid therapy, herb remedy and nutritional therapy in a concert as nature and taste as possible. No matter how this beverage can turn out, the main concept of gradually adjusting food structure to follow the light of optimal body structure and metabolism baseline need has never been changed.

The present art provides an unusually simple and practicable method for preparing a multi-phase food and drink, which are pleasing in taste and nutritious in composition.

18. Packing & Labeling

Preferably, this multi-phase food and beverage is packed and labeled by total calories of its content in gradually increased units. Particularly, such total calories are numbered in round figure (integer, whole number) ended with 5 and 0, such as in 20, 25, 30, 50, 70, 75, 100, 150, 200, 300, 500, 700, 1000, 1200, 1500, 1600, 1700, 1800, 1900, 2000, 2200, 2500, 2700, and 3000 calories.

To be more convenience for consumers to pick up the right food and beverage for their diet, this multi-phase food and beverage is directly packed and labeled by a reference comprising a customer's height, ideal body weight, gender, age, and activity. A human imagine, sound, and music can be added to above food and beverage label to establish a positive and pleasant drinking and eating reflection and habit.

The above description and examples may be modified to produce a variety of foods and beverages within the scope of this invention. These skilled in the art will recognize and be able to ascertain using no more than routine experimentation, many equivalents to the specific embodiments of the invention described herein. It is intended that all such variations within the scope and spirit of the appended claims be embraced thereby.

What is claimed and desired to be secured by United States Patent is:

1. A multi-phase food and beverage comprising at least one of the following:
(A) a liquid phase having a pH range from about 4.0 to about 8.2 and 0-7% by weight of simple sugar and sweetener, and 0-1.2% by weight of salt,
(B) an air phase, wherein said air essentially consisting of a gas carrying an aromatic smell, an inert gas, and a filtered gas,
(C) a solid phase having a water stable surface and a mean dense gravity close to water.

2. A multi-phase food and beverage comprising at least one of the following:
(A) a liquid phase having a pH range from about 4.0 to about 8.2, 0-7% by weight simple sugar and sweetener, 0-3% by weight of alcohol and 0-1.2% of by weight of salt,
(B) an air phase consisting of a gas carrying an aroma, an inert gas, ozone, N₂O, ether, and a filtered gas, wherein said aroma will be released under one of the following conditions:
1) when the pressure on said air phase is released,
2) when the temperature of said food mixture is rising,
3) when said food mixture is chewed,
(C) a solid phase having a water stable surface and a mean density gravity close to water.

3. The multi-phase food and beverage according to claim 1 wherein said solid having 10-100% by weight of water stable material essentially consisting of protein, fat, water-insoluble plant fiber, algae, and sea organism.

4. The multi-phase food and beverage according to claim 1 wherein said solid phase is aerated to reduce density gravity close to water suitable to float in a watery liquid.

5. The multi-phase food and beverage according to claim 1 wherein solid phase having a chamber, sealing and holding a fluid, wherein said fluid carrying a smell so that said smell is released when said chamber is opened.

6. The multi-phase food and beverage according to claim 1 wherein said solid phase having a fissure holding a fluid so that a voice is created when said fluid flowing through said fissure.

7. The multi-phase food and beverage according to claim 1 wherein a water unstable core is rotated in a solidable and water stable liquid, which is thereafter coagulated so that said water stable surface is formed and said water unstable core is covered.

8. The multi-phase food and beverage according to claim 7 wherein said water unstable core is a fluid inclusion,
wherein said fluid inclusion is first frozen to form a solid core and then is coated by a liquid material selected from the group consisting of protein, cheese, and chocolate, which is coagulated to form a water stable surface covering said solid core that finally regains flowing capacity in a consumable temperature.

9. The multi-phase food and beverage according to claim 1 wherein said solid is pre-curled and tighten in a dry condition into a consumer acceptable shape so that when a liquid is added, said pre-curled and tighten solid will absorb the moisture from said liquid and therefore extend and inflate to perform a motion in said liquid as a movable solid.

10. The multi-phase food and beverage according to claim 1, wherein said solid phase has a mean density gravity close to water and an eccentric gravity center so that when a liquid is added, an unbalanced gravity force from said eccentric gravity center drives said solid phase rotating to perform a motion in a liquid phase as a movable solid phase.

11. The multi-phase food and beverage according to claim 1 wherein said air phase is filtered through a pore ranging from about 1μ to about 10μ by diameter, preferably through a pore ranging from about 1μ to about 5μ by diameter.

12. The multi-phase food and beverage according to claim 1 is an aromatic air aerated beverage.

13. The multi-phase food and beverage according to claim 1 is a vegetable beverage.

14. The multi-phase food and beverage according to claim 1 is a soup beverage.

15. The multi-phase food and beverage according to claim 1 is a fast fermented grain beverage, wherein said grain being selected from the group consisting of whole rice, buckwheat, barley, rye, wheat, and millet with at least 50% integrity.

16. The multi-phase food and beverage according to claim 1 further comprising approximately Vc 45-400 mg, VB1 1.0-2.3 mg, VB2 1.0-2.0 mg, biotin 50-200 ug, VB6 1-10 mg, niacin 8-20 mg, VB12 2-6 ug, folate 50-400 ug, phentothenic acid 4-7 mg, VA 600-1000 ug, VE 7-14 mg, selenium 55-70 ug, chromium 50-200 ug, inositol 10-100 mg, carnitine 1500-4000 mg, zinc 10-15 mg, calcium 500-1,200 mg, magnesium 200-700 mg, Mg/Ca ≧1/2, Ca/P ≧2/1, potassium 2-5.5 g, sodium 0.5-2.4 g, and fluoride 1.5-4.0 mg.

17. The multi-phase food and beverage according to claim 1 is further packed and labeled by the total calories of said multi-phase food and beverage in gradually increased units, wherein the number of said total calorie comprising 20, 25, 30, 50, 70, 75, 100, 150, 200, 300, 500, 700, 1000, 1200, 1300, 1400, 1500, 1600, 1700, 1800, 1900, 2000, 2100, 2200, 2300, 2400, 2500, 2700, and 3000 calories.

18. The multi-phase food and beverage according to claim 1 is further packed and labeled by a reference comprising a customer's height, ideal body weight, gender, age, activity, and a combination thereof.

19. The food mixture according to claim 1 is further packed and labeled with a signal reference consisting of a human imagine, a sound, a voice, and a music.

20. A method of preparing a multi-phase food and beverage comprising at least one step of:
(A) providing a liquid phase having a pH range from about 4.0 to about 8.2 and 0-7% by weight of simple sugar and sweetener, and 0-1.2% by weight of salt,
(B) adding 0.5-7% by volume of air phase into a tangible phase consisting of liquid and solid, wherein said air essentially consisting of a gas carrying an aromatic smell, an inert gas, ozone, N₂O, ether, and a filtered gas,
(C) mixing a solid phase with a fluid phase consisting of air and liquid, wherein said solid having a water stable surface and a mean density gravity close to water.
